(19) United States
(12) Patent Application Publication
(10) Pub. No.: US 2011/0166712 A1
(43) Pub. Date: Jul. 7, 2011

(54) DEADBAND CONTROL OF PNEUMATIC CONTROL DEVICES

(76) Inventors: Marcus Kramer, San Diego, CA (US); Moses Derkalousdian, San Diego, CA (US); Scott Valoff, San Diego, CA (US)

(21) Appl. No.: 13/051,216

(22) Filed: Mar. 18, 2011

Related U.S. Application Data
(60) Provisional application No. 61/315,355, filed on Mar. 18, 2010.

(51) Int. Cl. G05D 23/19; G05D 23/12

(52) U.S. Cl. 700/278; 236/99 R

(57) ABSTRACT

Apparatuses and methods of deadband setpoint control of pneumatic controllers are described.

### RELATED APPLICATIONS

This application claims the benefit of Provisional Application No. 61/315,355, filed on Mar. 18, 2010, the entire contents of which are hereby incorporated by reference. This application is related to U.S. patent application Ser. No. 12/317,347, U.S. Patent Publication No. 2009/0192653, filed Dec. 22, 2008, which is commonly assigned to the present assignee.

### TECHNICAL FIELD

Embodiments of the present invention relate to the field of pneumatic control devices and systems, and more particularly to controlling, monitoring, and diagnosing pneumatic devices, and the like.

### BACKGROUND

Many control devices may be pneumatic based. Pneumatic-based control devices may control various systems based on a gas flow or pressure. Typically, such pneumatic control devices may include a “flapper” technology that may regulate a gas flow to thereby provide a pneumatic control signal.

One example of a pneumatic control device is a pneumatic thermostat. Pneumatic thermostats may be used as sensing and control devices for pneumatically controlled devices, such as variable air volume (VAV) units, ventilators, fan coil units, reheat coils, radiators, and the like, typically employed in a heating, ventilation, air conditioning (HVAC) system.

One type of pneumatic thermostat includes a pneumatic temperature controller, a setpoint cam, and a knob/slider. Such a pneumatic temperature controller may be a combination of a valve unit (typically a diaphragm type valve), a “flapper” controlled nozzle, and a bimetallic strip. A supply air is passed through the valve unit, which controls the pressure at an outlet, after allowing a portion of the supply air to exit into the atmosphere through the flapper-controlled nozzle. The outlet pressure can be used to pneumatically control another device.

Changes in a position of a flapper over the control nozzle may create corresponding changes in the amount of supply air exited to the atmosphere. This, in turn, may change the outlet air pressure.

A setpoint for such a pneumatic temperature controller may be manually set, by adjusting a cam position using a knob or slider. A cam position may change the amount of force applied by the bimetallic strip to the flapper. The position of the flapper may thus be determined by a resulting balance between the force exerted from the portion of supply air passing through the nozzle on one side, and the force generated by the bimetallic strip on another side. A force generated by a bimetallic strip may be proportional to a difference between a setpoint and the ambient temperature for the pneumatic thermostat.

In the above arrangement, when the ambient temperature is at the setpoint, the flapper may reach an equilibrium position, creating a certain clearance above the nozzle or force against the nozzle, which in turn creates a corresponding outlet pressure. However, when the ambient temperature is away from the setpoint in one direction, the bimetallic strip exerts less force on the flapper. This may move the flapper away from the nozzle increasing a clearance between the flapper and nozzle. Such increased clearance may allow more supply air to escape to the atmosphere, reducing the outlet pressure. Conversely, when the ambient temperature is away from the setpoint in the other direction, the bimetallic strip exerts greater force on the flapper. This may move the flapper closer to the nozzle, decreasing a clearance between the flapper and nozzle. Such decreased clearance results in less supply air escaping to the atmosphere, increasing the outlet pressure.

Like conventional pneumatic thermostats, conventional deadband pneumatic thermostats have fixed deadband spans that are manually controlled by a user. Calibration is likely infrequent, so unknown energy waste occurs if the deadband control pressure drifts out of calibration.

### BRIEF DESCRIPTION OF THE DRAWINGS

The present disclosure is illustrated by way of example, and not by way of limitation, in the figures of the accompanying drawings.

FIGS. 1A and 1B show block schematic diagrams of control devices, having deadband control, according to two embodiments.

FIG. 1C is a graph of a pressure and temperature transfer curve of a deadband pneumatic thermostat according to one embodiment.

FIG. 2A shows a block schematic diagram of a pneumatic control device having a metallic strip according to a further embodiment.

FIG. 2B shows a block schematic diagram of a two-pipe fixed regulator E/P concept according to one embodiment.

FIG. 2C shows a block schematic diagram of a one-pipe Electro-Pneumatic (E/P) concept having selectable, fixed-size orifices to set desired pressure according to two embodiments.

FIG. 2D shows a block schematic diagram of one-pipe and two-pipe pneumatic switch concepts according to one embodiment.

FIG. 3A illustrates a motor-driven pressure regulator of a HVAC thermostat according to one embodiment.

FIG. 3B-3D illustrate a dual stepper motor needle valve for a two-pipe pneumatic control device according to one embodiment.

FIG. 4A illustrates a flapper-nozzle assembly according to one embodiment.

FIG. 4B illustrates a cross-section of a high-capacity thermostat having the flapper-nozzle assembly of FIG. 4A according to one embodiment.

FIG. 5 illustrates schematic diagrams for regulator-based pneumatic controllers, valve-based pneumatic controllers, and stat-based pneumatic controllers for one-pipe and two-pipe applications according to various embodiments.

FIG. 6A illustrates a pneumatic diagram for a two-pipe application according to one embodiment.

FIG. 6B illustrates a pneumatic diagram for a one-pipe application according to one embodiment.

FIG. 6C illustrates a pneumatic diagram with Electro-Pneumatic (E/P) valves for a two-pipe application according to one embodiment.

FIG. 6D illustrates a pneumatic diagram with a single E/P valve for two-pipe application according to another embodiment.

FIG. 6E illustrates a pneumatic diagram with E/P valves for a one-pipe application according to one embodiment.

FIG. 7A illustrates a Microelectromechanical systems (MEMS) array of electrostatic flappers covering a series of micro-orifices according to one embodiment.

FIG. 7B illustrates a MEMS valve-based pneumatic thermostat according to one embodiment.

FIG. 8 is a diagram showing systems and system components according to embodiments.

FIG. 9A is a graph of pressure and setpoint curves with different throttle range settings according to one embodiment.

FIG. 9B is a graph of temperature and pressure curves at various setpoints according to one embodiment.

FIG. 10 is a temperature and pressure graph of a pneumatic thermostat, having an automatic calibration feature according to one embodiment.

FIG. 11 is a flow diagram of one embodiment of a method for deadband control.

FIG. 12 is a flow diagram of another embodiment of a method for wireless changing a deadband setpoint value.

FIG. 13 is a flow diagram of one embodiment of a method for measuring a pressure value to diagnose an error.

### DETAILED DESCRIPTION

Apparatuses and methods of deadband control of pneumatic control devices are described. In one embodiment, a deadband setpoint controller generates multiple setpoints, including a cooling setpoint and a heating setpoint of a specified deadband. The deadband setpoint controller controls a pneumatic controller, and in particular, varies a pressure of the pneumatic controller in response to the setpoints. In one embodiment, the pneumatic controller is a conventional mechanical single setpoint pneumatic controller without deadband functionality, and the deadband setpoint controller provides direct electronic control of the mechanical single setpoint pneumatic controller, as well as provides deadband functionality and energy savings. In another embodiment, the pneumatic controller is a conventional mechanical deadband pneumatic controller, and the deadband setpoint controller provides direct electronic control of the mechanical deadband pneumatic controller, providing enhanced functionality and energy savings.

The embodiments described herein may be compatible with existing site connections to enable rapid replacement of legacy control devices having manual deadband control, as well as to upgrade legacy control devices without manual deadband control to have deadband control. In both cases, the energy consumption of the building can be reduced with the addition of monitoring and control. In some embodiments, the control devices may be wired or wireless pneumatic thermostats (WPTs) that may replace existing, manually controlled mechanical pneumatic thermostats.

The embodiments described herein contribute to the more efficient utilization and conservation of energy resources, for example, by improving the energy consumption of existing pneumatic control systems. More specifically, the embodiments described herein may contribute to the more efficient utilization and conservation of energy resources by improving the energy consumption of existing HVAC systems, as well as providing new HVAC systems with improved energy consumption than the existing HVAC systems.

The following description sets forth numerous specific details such as examples of specific systems, components, methods, and so forth, in order to provide a good understanding of several embodiments of the present invention. In some of the following descriptions, apart from general reference characters ending with “00,” like features are referred to with the same reference character but with a first digit corresponding to the figure. It will be apparent to one skilled in the art, however, that at least some embodiments of the present invention may be practiced without these specific details. In other instances, well-known components or methods are not described in detail or are presented in a simple block diagram format in order to avoid unnecessarily obscuring the present invention. Thus, the specific details set forth are merely exemplary. Particular implementations may vary from these exemplary details and still be contemplated to be within the spirit and scope of the present invention.

References in the description to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

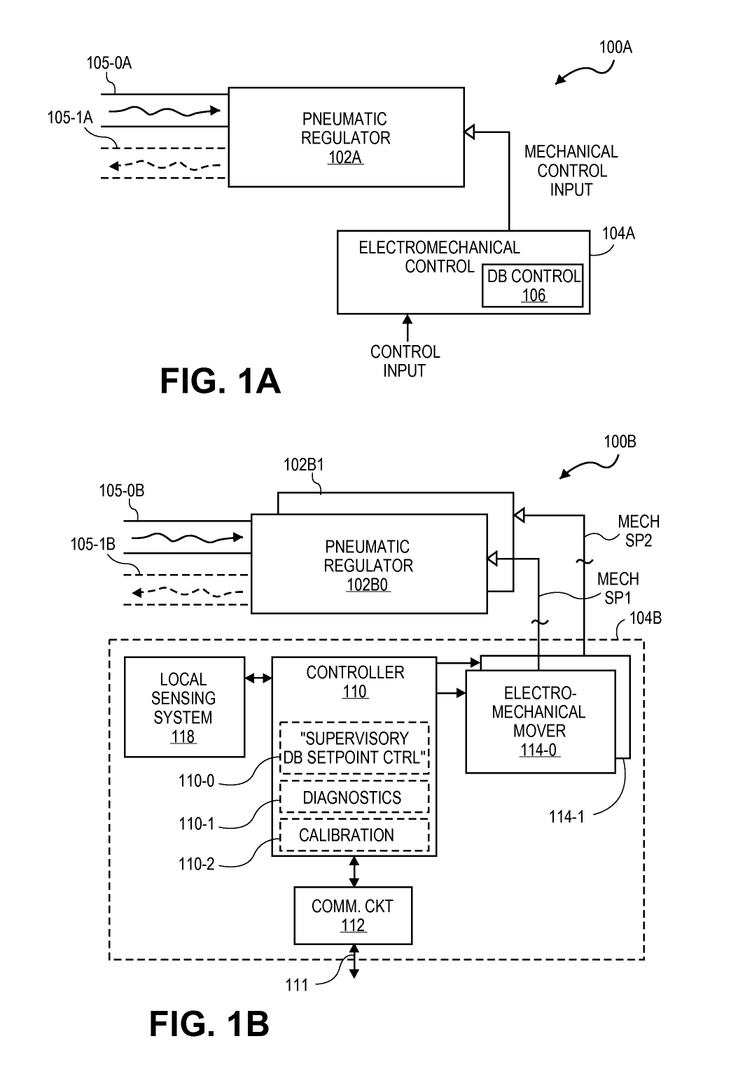

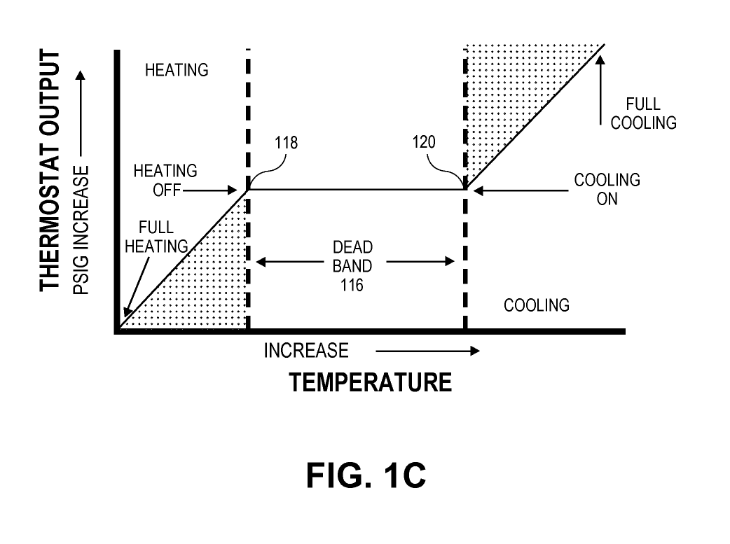

Referring now to FIG. 1A, one example of a control device 100A having deadband control 106 according to a first embodiment is shown in a block schematic diagram. The control device 100A may include a pneumatic regulator section 102A and an electromechanical control section 104A.

A pneumatic regulator section 102A may provide a regulatory control value based on pneumatics. For example, a pneumatic regulator section 102A may receive a gas and provide a gas pressure, or flow as a pneumatic control value. In the particular example shown, a pneumatic control section may have a gas flow inlet 105-0A that may receive a gas. In such an arrangement, a pneumatic regulator section 102A may selectively control how much a received gas is vented (e.g., to the atmosphere) to thereby generate a backpressure at gas flow inlet 105-0A that may be used as a control value for other pneumatic equipment. As but a few examples, such a pneumatic control value may regulate a temperature, a pressure, or humidity of a zone, or a flow of a gas to/from a zone.

In addition or alternatively, a pneumatic regulator section 102A may also have a gas flow outlet 105-1A. In such an arrangement, a pneumatic regulator section 102A may selectively control how much gas received at gas flow inlet 105-0A is output at gas flow outlet 105-1A. Thus, a gas flow outlet 105-1A may provide a control value for other pneumatic equipment.

Pneumatic regulator section 102A can regulate a gas flow according to a mechanical control input. A mechanical control input may be a force or position.

In some embodiments, a pneumatic regulator section 102A does not include electric elements, such as electromechanical actuators, solenoids, etc.

An electromechanical control section 104A can provide supervisory control over pneumatic regulator section 102A by generating a mechanical control input. More particularly, an electromechanical control section 104A may receive a control input signal, and in response to such a signal, generate the mechanical control input. A control input signal may be a digital signal, thus enabling a digital-to-pneumatic conversion. As will be described in more detail below, a control input signal may be one or more values stored in the electromechanical control section 104A that have been received from a location remote to the control device 100A.

In this way, a control device may include a pneumatic control section that provides full pneumatic regulation, as well as an electromechanical section that generates a mechanical input for supervising operation of the pneumatic control section.

In this embodiment, the electromechanical control section 104A includes the deadband control 106. The deadband control 106 may receive one or more control input signals, and in response to such signals, generate one or more mechanical control input to the pneumatic regulator 102A. In one embodiment, the deadband control 106 generates multiple setpoint inputs, including a cooling setpoint and a heating setpoint for a specified deadband for the pneumatic controller (e.g., pneumatic regulator 102A). A deadband is an area of a single range or band where no action occurs. Deadbands can be used to prevent oscillation or repeated activation-deactivation cycles and to reduce energy consumption. As described herein, in some embodiment, the deadband control 106 can be used with conventional mechanical single set-point pneumatic controllers that do not have deadband functionality, and the deadband control 106 of the electromechanical control section 104A allows the pneumatic controller to achieve deadband functionality and energy savings. In other embodiments, the electromechanical control section 104A, having the deadband control 106, can be used with conventional mechanical deadband pneumatic controllers, which are manually controlled, to provide enhanced functionality and energy savings.

Referring now to FIG. 1B, a control device 110B having a supervisory deadband setpoint controller according to an alternate embodiment is shown in a block schematic diagram. The control device 100B may differ from the particular embodiment shown in FIG. 1A in that it may include multiple pneumatic regulator sections 102B0 and 102B1. As but one example, each pneumatic regulator section (102B0 and 102B1) may provide one or more control outputs for different purposes (e.g., one for heating, one for cooling) to each of the multiple pneumatic regulator sections 102B0 and 102B1. It is understood that pneumatic regulator section 102B1 may include its own corresponding gas flow inlet, and optionally a gas flow outlet (not shown in FIG. 1B).

Correspondingly, an electromechanical control section 104B may provide one or more different mechanical input to each different pneumatic regulator section (102B0 and 102B1). In the particular embodiment of FIG. 1B, electromechanical control section 104B may apply a first set of one or more mechanical setpoints (MECH SP1) to pneumatic regulator section 102B0, and apply a second set of one or more mechanical setpoints (MECH SP2) to pneumatic regulator section 102B1. The first and second sets may each include a heating setpoint and a cooling setpoint. Alternatively, the first set may include one or more heating setpoints and the second set includes one or more cooling setpoints, or vice versa.

In the depicted embodiment of FIG. 1B, an electromechanical control section 104B may include a controller circuit 110, communication circuit 112, electromechanical movers 114-0 and 114-1, and a local sensing system 118. A controller circuit 110 may be in electrical communication with communication circuit 112, electromechanical movers 114-0/1, and local sensing system 118.

A controller circuit 110 may execute predetermined functions in response to predetermined input signals. As but a few examples, a controller circuit 110 may include any of: a supervisory deadband setpoint controller 110-0, a diagnostics manager 110-1, and a calibration controller 110-2. Such functions will be described in more detail below. In some embodiments, a controller circuit 110 may also receive manual input values entered by a user into the control device via an input interface (e.g., buttons, touch pad, dial etc.).

A communication circuit 112 may provide input data to controller that is received on a connection 111. For example, communication circuit 112 may provide input setpoint values. Such values may be translated into control inputs to prime movers, to thereby generate a mechanical input in response to a received control value. A connection 111 may be a wired communication link or a wireless communication link. Thus, a communication circuit 112 may include at least a receiver for receiving data. In addition, a communication circuit 112 may transmit data as determined by control signals/data received from controller circuit 110. Accordingly, a communication circuit 112 may also include a transmitter. In a very particular embodiment, a communication circuit 112 may include a wireless transceiver.

Electromechanical movers 114-0/1 may generate a mechanical output in response to control inputs from controller circuit 110. A mechanical output from an electromechanical mover may generate, directly or indirectly (by way of some mechanical linkage, for example), an applied setpoint to a corresponding pneumatic regulator section 102B0/1. Particular examples of electromechanical movers may be pneumatic motors, electrical motors, piezoelectric device, or the like. Pneumatic motors receive control values from the controller circuit 110, and in addition, a pressure from a gas input. In response to control values, the pneumatic motor may convert pressure from the gas input into a mechanical output, such as a force or change in position. For example, the pressure from the gas input may be taken from an inlet flow of the control device. The electrical motor may receive control values from the controller circuit 110, and in addition, electrical power may be received at a power input. In response to the control values, the electrical motor may generate a mechanical output (e.g., force, linear movement, rotational movement). Alternately, depending upon the amount of electricity needed to generate a desired mechanical output, electrical energy needed by electrical motor may be provided by the controller circuit 110. The piezoelectric device may receive control values from the controller circuit 110, and in addition, electrical power may be received at a power input. In response to control values, a voltage may be applied to a piezoelectric material, causing the piezoelectric device to alter its shape. As in the case of the electrical motor, depending upon the amount of electricity needed to generate a desired mechanical output, the controller circuit 110 may provide electrical energy needed by the piezoelectric device. Of course, the above are but a few examples of possible prime movers. Further, alternate embodiments may include prime movers composed of combinations of the above.

A local sensing system 118 may sense or otherwise make a determination regarding one or more conditions of a zone corresponding to the control device 100B. Such a zone may be an area proximate to the control device. As but a few of the many possible examples, a local sensing system may sense any of: zone temperature, zone occupancy, or zonetime. Such values may be forwarded to controller circuit 110. In response to such values, a controller circuit 110 may make a determination (e.g., zone is occupied or not, etc.).

In addition or alternatively, a local sensing system 118 may make a determination regarding a zone condition itself, and forward such a determination result to a controller circuit 110. Controller circuit 110 may then transmit such a value by way of communication circuit 112. In this way, a control device 100B may monitor a corresponding zone.

Referring still to FIG. 1B, a supervisory deadband setpoint controller 110-0 may provide control signals for activating electromechanical movers 114-0/1. For example, in response to setpoint data, supervisory deadband setpoint controller 110-0 may generate signals that induce a movement in electromechanical movers 114-0/1. That is, as deadband setpoint data varies, movement in electromechanical movers 114-0/1 may vary correspondingly. Supervisory deadband setpoint controller 110-0 may opt between different setpoint values based on other conditions, such as time of day, or values provided by local sensing system (e.g., occupancy). That is deadband setpoint data may vary according to zonetime and/or condition. Further, while a controller circuit 110 may receive manual setpoint values, a supervisory deadband setpoint controller 110-0 may override such values based on predetermined criteria (e.g., limits, time of day, time or year, outside temperature, etc.).

The deadband control 106 and the supervisory deadband setpoint controller 110-0 may enable two setpoints to be programmed instead of one set point as done conventionally. For example, in pneumatic thermostats, the heating could be programmed for 68 degrees Fahrenheit and cooling could be programmed for 78 degrees Fahrenheit. The pneumatic thermostat would not call for heating or cooling when the ambient temperature is between the two setpoints and the pneumatic thermostat would call for cooling when the ambient temperature rises above 78 degrees and would call for heating when the ambient temperature falls below 68 degrees. In another embodiment, more than two setpoints may be used. For example, additional setpoints can be selected beyond those defining start of heating and cooling to define the start of a different throttle range (e.g., slope or rate of change of the control response). This can help ensure that the ambient temperature never gets too far away from the setpoint, without having an immediate aggressive response.

FIG. 1C is a graph of a pressure and temperature transfer curve of a deadband pneumatic thermostat according to one embodiment. The pressure and temperature transfer curve indicates that as the temperature increases, the pressure increases until the temperature reaches a first setpoint 118 of a deadband 116. When the temperature is within the deadband 116, there is no corresponding increase or decrease in pressure. However, when the temperature exceeds a second setpoint 120, the pressure increases. In the depicted embodiment, the transfer curve represents the deadband 116 of a direct-acting deadband pneumatic thermostat, in which the first setpoint 118 is a heating-off setpoint and the second setpoint 120 is a cooling-on setpoint. Alternatively, the deadband may be inverted for a reverse-acting deadband pneumatic thermostat. In one embodiment, the deadband 116 is fixed. In another embodiment, the deadband 116 may be dynamically adjusted using the electromechanical control section 104A. The electromechanical control section 104A may receive the adjustment inputs locally or remotely as described herein. For example, in one embodiment, the deadband can be dynamically adjusted wirelessly. In one embodiment, the deadband can be adjusted based on different days, nights, weekends, seasons, or the like. This allows for an easy tradeoff between desired comfort and desired energy savings. As described herein, the deadband settings can be manually changed at the pneumatic thermostat, a remote server that controls the pneumatic thermostat, or automatically according to a schedule managed by the electronics at the pneumatic thermostat or at the remote server.

Embodiments of the deadband pneumatic thermostats may save up to 60% of HVAC energy, depending on factors such as local setpoint policies, climate, building type, etc. Embodiments of the deadband pneumatic thermostats may enable automatic enforcement of deadband setpoint policies, which cannot be enforced with conventional mechanical pneumatic thermostats. Embodiments of the deadband pneumatic thermostats may be used in any facility that currently has pneumatic thermostats, including conventional mechanical single-setpoint pneumatic thermostats and mechanical deadband pneumatic thermostats.

As described herein, the deadband control 106 and the supervisory deadband setpoint controller 110-0 may provide various deadband features, including a feature to dynamically adjust deadband setpoints, a feature to adjust the neutral output pressure (also referred to herein as steady branch pressure, steady balance pressure, or idle branch pressure), a feature to allow remote control, a feature to allow remote monitoring of temperature and pressures, a feature for operator notifications of excursions, a feature for automatic calibration, a feature for programmable temperature setbacks, a feature for occupancy override, a feature that enables auto-demand response strategies, and/or an interface feature for integration with building management systems, etc. The embodiments described herein may be used in direct-acting or reverse-acting systems, in one-pipe or two-pipe configurations, or any combination thereof. The embodiments described herein may be directly compatible with existing mechanical deadband pneumatic thermostats from major vendors, and may be compatible with mechanical pneumatic thermostats from major vendors, such as, for example, Johnson, Honeywell, Siemens, Robertshaw, and TAC pneumatic thermostats.

In this way, a control device may include an electromechanical control section that may receive setpoint values via a communication path, and translate such values into mechanical outputs that form multiple setpoints to a pneumatic regulator section to provide deadband functionality. The pneumatic regulator section can generate a pneumatic control output in response to the applied setpoint(s). Supervisory, diagnostic and/or calibration may be performed automatically. The supervisory, diagnostic and/or calibration may also be performed locally where the control device is installed, or remotely from where the control device is installed. In such embodiments, the supervisory, diagnostic and/or calibration may be performed without user interaction at the control device as would be appreciated by one of ordinary skill in the art having the benefit of this disclosure.

As described herein, the deadband control 106 and the supervisory deadband setpoint controller 110-0 may be integrated in deadband pneumatic thermostats. In one embodiment, the deadband pneumatic thermostat may be a drop-in, intelligent retrofit for a conventional deadband pneumatic thermostat. In this embodiment, an installer removes the conventional deadband pneumatic thermostat and installs an electronic device in its place to provide a superset of functionality, including the deadband features described herein. In another embodiment, the deadband pneumatic thermostat may be a drop-in, intelligent retrofit of a conventional pneumatic thermostat to provide it with deadband functionality. This embodiment adds deadband functionality where it did not exist before. In another embodiment, additional processing logic (e.g., hardware, software, firmware or any combination thereof) can be added to a pneumatic based controller to provide two or more setpoints on a thermostat designed for only a single-setpoint pneumatic controller, such as described in U.S. Patent Publication No. 2009/0192653, filed Dec. 22, 2008, which is commonly assigned to the present assignee.

In one embodiment, the electromechanical control section 104A is conceptualized as a “virtual thumb,” as it may provide a mechanical adjustment to a pneumatic controller (such as that which could be performed by a human thumb) in response to control values, such as setpoint values. The “virtual thumb,” however is controlled locally according to manual inputs into the electromechanical control section 104A, according to a local schedule, according to inputs received over a wired or wireless connection, or according to a remote schedule operated by a remote server that remotely controls the electromechanical control section 104, as described herein.

Referring back to FIG. 1B, a diagnostics manager 110-1 may diagnose an improper control device 102B operating condition. In some embodiments, a diagnostics manager 110-1 may monitor various values of a control device and diagnose an error condition if such values are outside a given range. As but a few examples, a diagnostics manager may monitor a pressure at a gas inlet (e.g., 105-0B) or at an outlet (e.g., 105-1B), an electrical power level, and a status of connection 111 (signal strength, etc.). In addition or alternatively, a diagnostics manager 110-1 may make diagnoses based on operating responses of a control device 100B. That is, a control device 102B response (or response of a monitored zone) may be compared to an expected response to determine if an error should be diagnosed. More particular examples of such operations will be described below in conjunction with other embodiments.

A calibration controller 110-2 may calibrate a control device 100B to account for changes (e.g., drift) in the response of the device. As but one example, the control signals output from a controller circuit 110 in response to input setpoint values can be changed, to ensure a generated response from electromechanical mover(s) 114-0/1 results in a desired response from a corresponding pneumatic regulator section 102B0/1. In one embodiment, the controller 110, using the calibration controller 110-2, or a remote server can detect if a zone is out of calibration, and can adjust accordingly. For example, the temperature may rapidly drift to high or low end of the deadband and stay there. The controller 110 or server can compare the neighboring zones and outside air temperature to know if an external influence or a faulty zone causes the drift. In another embodiment, the server can calculate energy savings from the deadband behavior. For example, the server may compare data logs of before and after, and may analyze temperature trends to determine heat/cool loads for the zone, and subtract the duration the deadband is active. More examples of calibration operations are described herein in conjunction with other embodiments.

Conventional pneumatic thermostats do not have any indicator for main or branch pressure. As such, conventional pneumatic thermostats require a technician to connection special equipment for diagnostics. For example, the technician may use a temporary pressure gauge to examine the main pressure issues on individual pneumatic thermostat. The technician may also use a pressure regulator to test and calibrate HVAC actuators and spring rates. Some pneumatic thermostats may use a single pressure sensor, but the single sensor is typically only used for measuring pressure of the branch line for feedback control. A main pressure sensor can be added to the pneumatic thermostat for additional diagnostics and energy savings, but at a cost penalty.

In one embodiment, this added cost of adding another sensor can be avoided, by the controller 110 examining historical data to notice an offset in pressure based on the setpoint and ambient temperature. For example, a server, or the deadband setpoint controller 2110 of the pneumatic thermostat (e.g., referred to herein generally as WPT), can examine the historical data to determine the offset in pressure based on the ambient temperatures and setpoints. This offset may be due to a calibration error or a main pressure error. In another embodiment, the server or WPT can examine historical data to notice any oscillations in pressure during a period of time when the ambient temperature is table. This can indicate a malfunctioning compressor, system regulator, or leak in the tubing. In another embodiment, the WPT can operate in an existing pneumatic HVAC system that uses two different main pressure levels to implement summer/winter or day/night control. The WPT or server can periodically monitor the main pressure for a mode change, and can then alter its setpoints and behavior accordingly. This allows WPTs to be installed in systems that need to maintain the dual pressure-level feature for other legacy thermostats in the system. The server or WPT can use various methods to temporarily re-purpose the branch pressure sensor to detect the main pressure. The branch pressure sensor may be a single pressure transducer configured to measure both branch and main pressure.

In one embodiment, the server or WPT temporarily selects an extreme heat/cool position, at a selected time where the branch pressure equals the main pressure, then measures the pressure, and then returns to a normal state. This can be done by temporarily rotating the motorized cam mechanism (or other setpoint control mechanism) to an extreme position. For one-pipe application, closing the vent should cause the pressure to build the main pressure. This process can be done intelligently to avoid having the tenant notice the brief change. For example, while already in heating mode, the system can be maxed out briefly. If the main pressure can't reach the branch pressure, then there is a leak either upstream or downstream, or an issue with the pressure regulator or compressor. Then the motorized cam mechanism can be returned to a normal setpoint position.

In another embodiment, the WPT can include a low-cost pneumatic selector relay or latching solenoid valve that can be controlled to temporarily switch the branch pressure sensor to measure main pressure instead of branch pressure. In another embodiment, the server can compare the reading of multiple zones to further localize the program, such as by checking for consistency for results for all zones, versus localized problems (e.g., compressor, regulator, tubing, etc). In another embodiment, processing logic can observe changes in branch pressure with respect to ambient temperature and setpoints to deduce changes in main pressure without directly measuring the main pressure. For example, if ambient temperature is steady, and the setpoint is steady, but branch pressure is not, then it is likely due to a varying mains pressure. Or, if the main pressure changes very slowly over time, the processing logic can keep a history of different data points to compare the current ambient temperature/setpoint/pressure to determine if the pressure is in an expected range. This may serve as an additional check of pressure based on the demanded heat/cool load.

In other embodiments, the server or WPT can diagnose additional branch problems. In one embodiment, the server or WPT monitors the main pressure, and compares the main pressure to the expected branch pressure for each temperature setting. An out of specification reading may indicate a calibration or a leak issue. In another embodiment, the server or WPT can diagnose small branch leaks using a single pressure sensor along with one of the electronically-controlled valves, as described herein (not conventional existing pneumatic regulators). In this embodiment, the server or WPT can control the pneumatic thermostat to charge up the branch line pressure, then shut off the supply, and monitor branch pressure over time to detect a leak. In one embodiment, if all WPTs are wirelessly reporting a consistently low main pressure (when they execute a pressure check), then the server can conclude that the issue is related to the pressure regulator or compressor instead of a leak in the piping. Similarly, if all WPTs report varying main pressures, that can help to narrow down on the location of the leak. Processing logic can also notice cycling pressure when in steady state. This may be caused by the compressor cycling more frequently due to a leak, or by a malfunctioning pressure regulator.

In another embodiment, the server or WPT can detect valve clogs, regulator clogs, or orifice clogs by recording the time the pressure rises when starting from a closed position to a full open position. For example, the server or WPT can record a baseline at installation, and then test this periodically to detect clogs. In another embodiment, the server or WPT can detect a hose popping completely off, causing a large leak using similar techniques as described above. In another embodiment, during installation or troubleshooting, the system can allow direct pressure control. For example, the system can allow a user to command a pressure, and the motorized cam mechanism tracks the ambient temperature to compensate for the bi-metallic strip to maintain that pressure. This can be used to validate or calibrate HVAC actuator positions, for example.

These calibration embodiments do not require a human technician to manually detect these issues. These embodiments may reduce the cost of adding an extra pressure sensor, may reduce the cost of the system, the size of the system, and may increase the reliability of the system. By measuring the main and branch pressures, the system can proactively diagnose issues that can affect tenant temperature comfort, waste energy, cause ambient noise (e.g., leaks), and reduce the life of the compressor.

In another embodiment, the server or WPT can diagnose HVAC equipment failures. Conventionally, problems were detected only in response to tenants' complaints about comfort, and required manual troubleshooting. For example, the technician would connect tools and use other equipment to run experiments on an individual zone to diagnose problems. Using the embodiments described herein, the server or WPT can automatically check expected HVAC responses versus actual responses. If the system repeatedly failed to respond as expected, the server or WPT could set an alert with the estimated issue to target troubleshooting. In particular, the WPT or server can use historical data (local or remote data) and processing logic to notice consistent pattern of failing behavior, instead of a local anomaly. In one embodiment, the server or WPT compares expected temperature response against actual temperature curves. The server or WPT may use data from neighboring zones (also stored on the server) as input into the algorithm. The server or WPT may determine if adjacent zones supports or contradicts a failure theory. The server or WPT can automatically compensate for soft-failures, such as out of calibration, over-heating/cooling, under heating/cooling. For under-heating/cooling, the server or WPT can use historical data to predictively apply heating/cooling early to prevent failing behind. For over-heating/cooling, the server or WPT can also use historical data to soften the response to avoid oscillations and overshoot (e.g., wasted energy). In a special mode, a user can specify desired pressure, and the server or WPT can control the motor or other E/P valve solution to automatically adjust setpoint to track and maintain selected pressure. This may be useful for diagnosing and calibrating HVAC actuators.

In another embodiment, the system includes a wireless temperature sensor disposed near an HVAC vent on which the pneumatic controller is acting, and the server or WPT uses the temperature sensor to monitor zone temperature and airflow. The wireless temperature sensor can communicate this information to the WPT to provide additional feedback to detect or compensate for incorrect calibration or faulty behavior. For example, the controller can use the wireless temperature sensor to know if the vent is outputting the temperature that the controller is requesting so it can make self-calibration adjustments. As described herein, the temperature sensor can be used for deadband to ensure there is truly no heating/cooling inside the deadband zone.

The embodiments described above may reduce the time to troubleshoot and the equipment required for troubleshooting. The embodiments may also be used to alert service personnel with minimal human discomfort, such as by discovering the problem early, and compensating for the problem in some cases before tenants complain. In some cases, the system uses significant amount of data to generate accurate error diagnosis, and in some cases can self-correct to save energy and maintain comfort. Also, conventionally, maintenance personnel go around and physically recalibrate each pneumatic thermostat individually. This maintenance is often avoided until a large problem is determined. The maintenance personal connects test equipment to the system and adjusts a set-screw to re-center the pneumatic thermostat. The maintenance personnel also must carefully allow the pneumatic thermostat to stabilize to ambient temperature, which can be a very time-consuming process. In some embodiments, the server or WPT can use historical data and processing logic to automatically determine if there is a calibration offset. The server or WPT can monitor periods of stable temperature and pressure to observe any consistent offsets not due to dynamic effects. The server or WPT may automatically ignore unoccupied times and may examine historical data from neighboring zones and other sensors as inputs into the algorithm. This data may help explain unusual behavior in one or more zones, and avoid an incorrect calibration. In one embodiment, the WPT can self-calibrate without using the server. In one embodiment, the WPT can self-calibrate for deadband control. It should be noted that the WPT can self-calibrate for deadband control, but could also self-calibrate control outside of the deadband. When the motor is tracking neutral pressure, for example, the WPT can measure and record offset/error data at multiple temperatures within the deadband. This data can be recorded in a table, and the WPT can use the table to extrapolate for errors outside of the deadband. The WPT can automatically adjust for the offset with the WPT electronic actuator (motor, piezoelectric, etc). In another embodiment, the server alerts the maintenance personnel if the offset is too large to compensate for with the WPT's actuator. In another embodiment, the WPT optimizes the process of calibrating the setpoint set-screw on a bi-metallic system. In a special mode, the motor automatically tracks the ambient temperature to maintain the ideal “center” position. In this case, the installer may simply adjust the calibration screw until the installer reads the neutral pressure on an LCD. This may provide a maximum range of temperature control, there is no need to manually set setpoints to match ambient temperature, and there is no need to continuously change setpoints to manually track a changing ambient temperature. Although the installer may still wait for the temperature to settle, the installer does not have to manually adjust the setpoint to match the ambient temperature. Another option may be to allow for automatic calibration of the unit after the temperature has settled (i.e., after the installer leaves), but this may not provide “maximum range”, since it could use some of the dynamic range of the system, depending on how much overhead we have in the adjustment range.

These embodiments may store large amounts of historical data on the server for accurate calibration of the WPTs in the network. The WPTs may also be configured to calibrate themselves or re-calibrate themselves periodically. These embodiments may be maintenance-free solutions or minimal maintenance solutions, and may avoid surprise problems, and catch issues before the tenants would likely notice the problem.

Described below are various embodiments of different types of pneumatic regulators 102B0/1, and electromechanical control sections 104B.

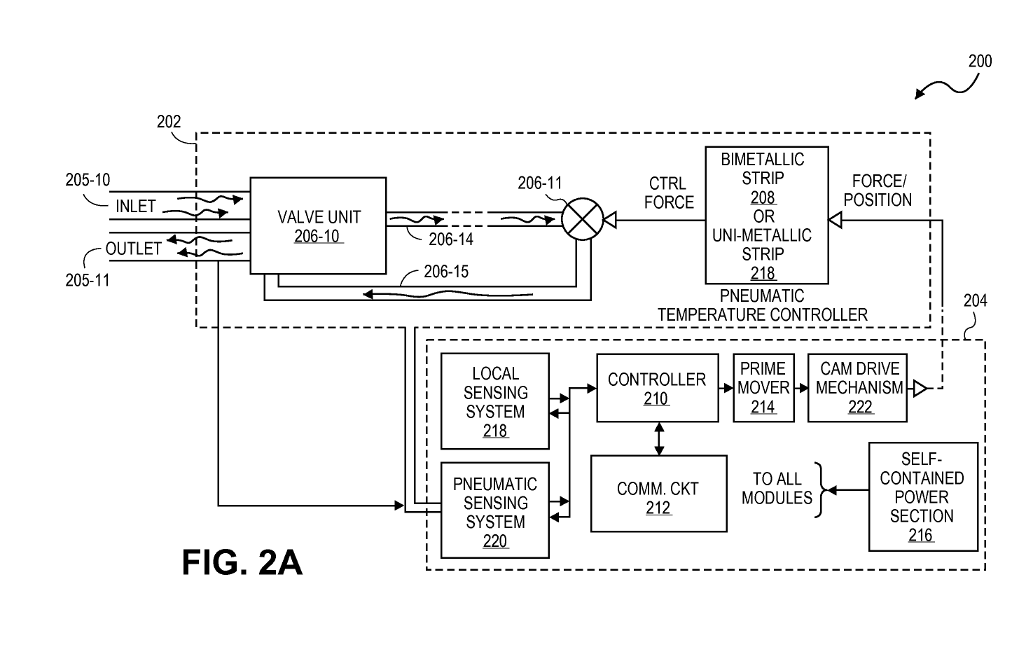

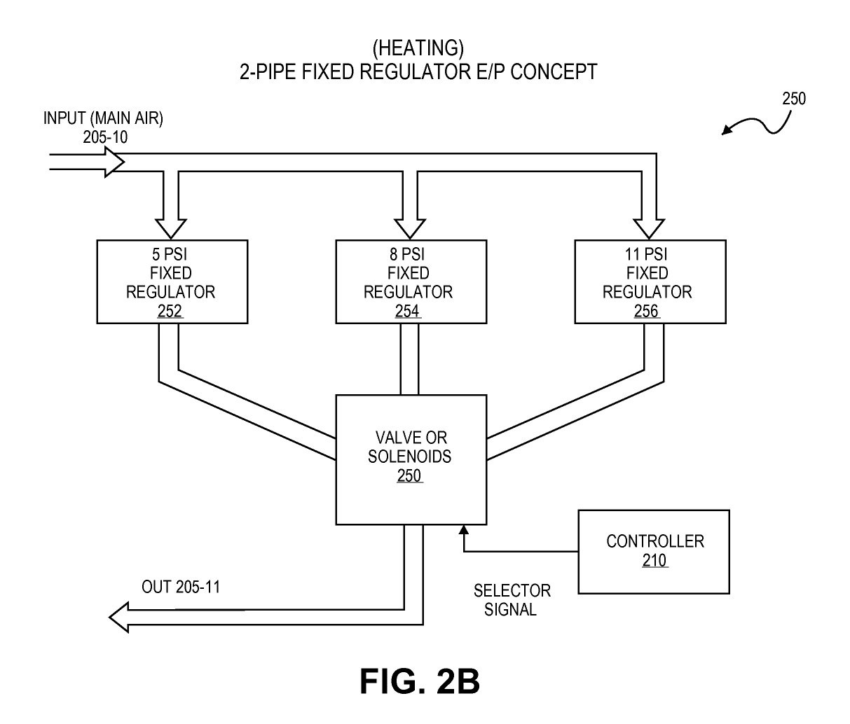

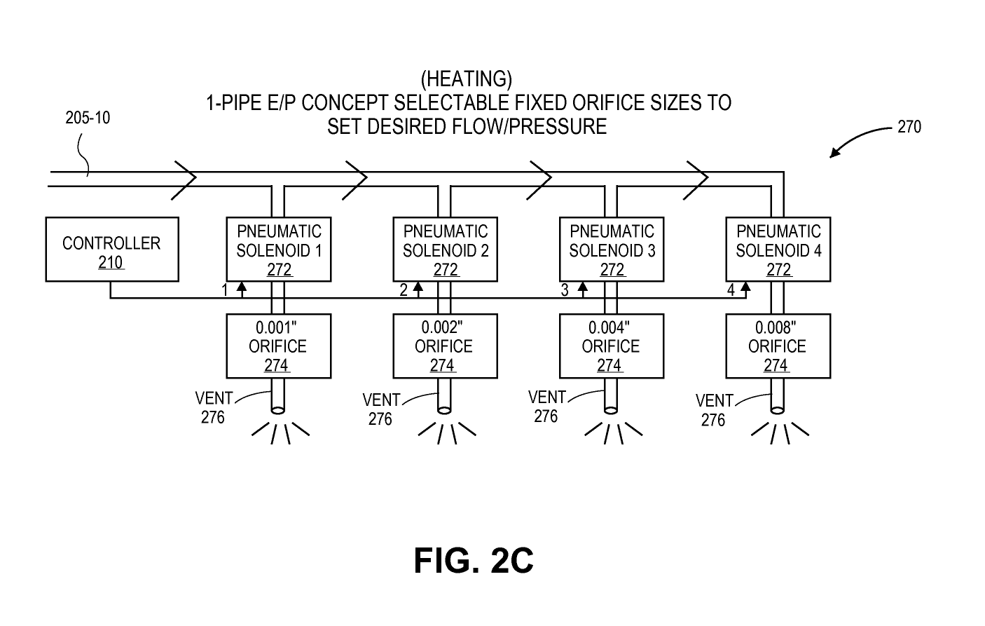

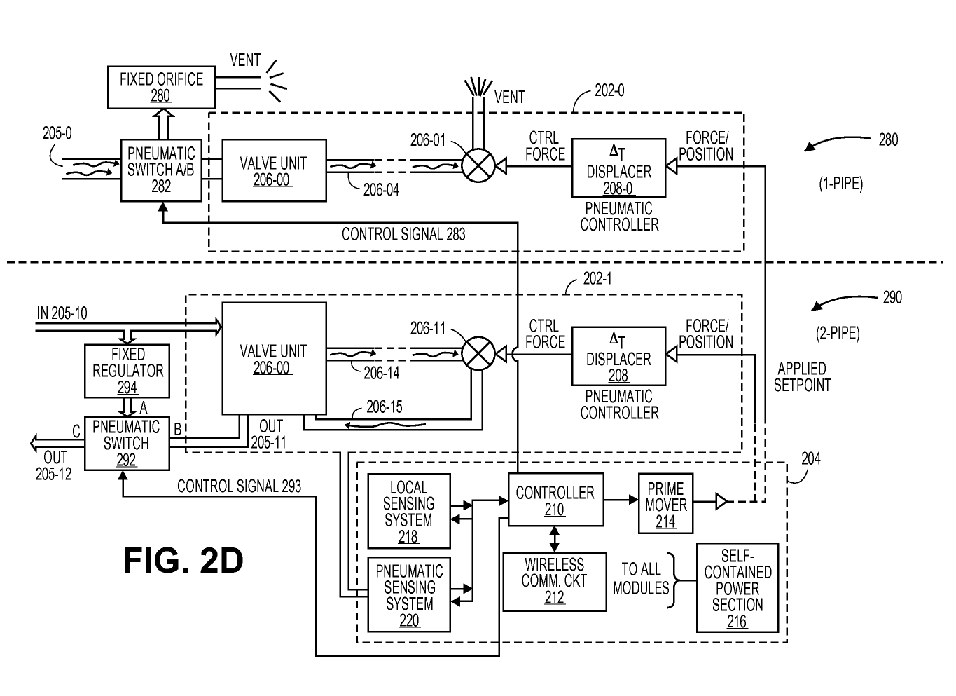

In other embodiments, a motor can be coupled to any type of pressure regulator (1-stage, 2-stage, etc.), and driven (by the controller) to the desired position to select a specific pressure based on setpoint and ambient temperatures (such as illustrated in FIG. 2A). In these embodiments, no power is used while regulating to a selected pressure. Many types of pressure regulators can compensate for varying input pressure, eliminating most offset errors. These embodiments may compensate for changes in input pressure, and may provide a simple solution that can be used with existing mechanical pneumatic thermostats. For example, two models may replace all variants of existing mechanical pneumatic thermostats. These embodiments are reliable, low cost, low power, and may provide precise flow control and high performance. The systems using the motorized pressure regulators can provide PID control, instead of only proportional control. As above, a single motorized pressure regulator can be used for two-pipe control.

In other embodiments, one or two pneumatic solenoid valves may be used for one-pipe and two-pipe systems (such as illustrated in FIG. 2B). For a two-pipe system, the pneumatic solenoid valve may be actuated only during a pressure change event, such as to charge or vent the branch line. Otherwise, no power is consumed while a steady pressure is maintained. For a two-pipe system, the pneumatic solenoid vale may be periodically pulsed open to create the required charging or venting flow to hold a steady pressure. The pneumatic solenoid valve embodiments are reliable, low cost, low power, and may provide precise flow control and high performance. The systems using the modulated solenoid valve can provide PID control, instead of only proportional control.

In other embodiments, an array of fixed-pressure regulators can be used to control the pressure in a two-pipe system (such as illustrated in FIG. 2D). In one embodiment, a latching pneumatic switching valve selects the desired fixed regulator (or combination of fixed regulators). In this embodiment, power is only consumed when actuating the switch to select between regulators, and no power is used to maintain a steady pressure. In one embodiment, a HVAC system uses a minimum of three fixed-pressure regulators, such as 5 psi, 8 psi, and 11 psi. Alternatively, additional fixed-pressure regulators may be used, such as 4 psi, 6 psi, 8 psi, 10 psi, 12 psi, or the like.

In other embodiments, a ladder arrangement of orifices can be used to control the rate of venting (and thereby pressure) in a one-pipe system (such as illustrated in FIG. 2C). In this embodiment, latching pneumatic valves or solenoids are used to select one or more orifices in combination to achieve desired flow rate. For example, the orifice sizes (e.g., 0.001″, 0.002″, 0.004″, and 0.008″) may be selected to provide adequate resolution. In these embodiments, no power is used to maintain a steady pressure. These embodiments provide a reliable and simple solution.

FIGS. 2A-2D illustrate various embodiments of control devices that may be used in deadband pneumatic control devices, such as deadband pneumatic thermostats having a deadband setpoint controller, as described below. However, in other embodiments, the control devices may be used in non-deadband pneumatic control devices, networked pneumatic control devices, standalone pneumatic control devices, or the like, as would be appreciated by one of ordinary skill in the art having the benefit of this disclosure. As such, the embodiments described below in context to the deadband setpoint controller can be done by other types of controllers in these other types of pneumatic control devices as would be appreciated by one of ordinary skill in the art having the benefit of this disclosure.

FIG. 2A shows a block schematic diagram of a pneumatic control device 200 having a metallic strip according to a further embodiment. Control device 200 differs from that of FIGS. 1A and 1B in that a pneumatic regulator section may be a temperature dependent pneumatic controller. In the depicted embodiment, the pneumatic regulator section 202 is a “two-pipe” pneumatic regulator section. In other embodiments, the pneumatic regulator section 202 is a “one-pipe” pneumatic regulator section.

In the depicted embodiment, the electromechanical control section 204 includes a communication circuit 212, a deadband setpoint controller 210, a prime mover 214, a cam drive mechanism 222, a local sensing system 218, a pneumatic sensing system 220, and a self-contained power section 216. In one embodiment, the deadband setpoint controller 210 includes deadband control 106 of FIG. 1A. In another embodiment, the deadband setpoint controller 210 includes the supervisory deadband controller 110-0 of FIG. 1B. In one embodiment, the communication circuit 212 is a wireless communication circuit having a wireless receiver and transmitter and/or a wireless transceiver. In this embodiment, the control device is a wireless pneumatic thermostat (WPT) device. The deadband setpoint controller 210 uses the communication circuit 212 to communicate with a remote server. In one embodiment, the remote server remotely controls the deadband setpoint controller 210. In another embodiment, the remote server sends data to the deadband setpoint controller 210, such as a schedule to manage the setpoints of the deadband at different setpoints at different times and/or days as described herein. In another embodiment, the deadband setpoint controller 210 can send data back to the remote server using the communication circuit 212 as would be appreciated by one of ordinary skill in the art having the benefit of this disclosure.

In one embodiment, the prime mover 214 may be electromechanical mover that initiates an initial mechanical action that results in the application of the setpoint to the pneumatic regulator section 202. In one embodiment, the prime mover 214 is an electrical motor that receives control values from the deadband setpoint controller 210, and generates a mechanical output (e.g., force, linear movement, rotational movement). In another embodiment, the prime mover 214 is a piezoelectric device that receives control values from the deadband setpoint controller 210. In response to the control values, a voltage may be applied to a piezoelectric material, causing the prime mover 214 to alter its shape, generating a desired mechanical output. In another embodiment, the prime mover 214 may be an electromechanical/pneumatic mover. Alternatively, other types of prime movers may be used as would be appreciated by one of ordinary skill in the art having the benefit of this disclosure.

In the depicted embodiment, the prime mover 214 is mechanically coupled to the pneumatic controller 202 by a cam drive mechanism 222. This may enable a linear mechanical motion to be translated into a rotational motion, or vice versa.

In one embodiment, the pneumatic sensing system 220 is configured to sense a gas pressure at one or more locations of a pneumatic regulator section 202. Such a sensed pressure may allow diagnostic and calibration functions to be based on one or more such flow values. The self-contained power section 216 may be configured to provide power to electromechanical control section 204. The self-contained power section 216 may include a charger and a power source. The charger may harness conditions of the environment to generate electrical energy and provide it to the power source. The power source may provide electrical energy to various modules of the deadband setpoint controller 210. The charger may include one or more photovoltaic cells that are charged in response to light present at the zone corresponding to the control device. Alternatively, the power section may include a turbine to generate power. This energy may be stored (e.g. in a battery), regulated, and/or applied directly by the power source. In another embodiment, the power section 216 may include a battery or a “super-capacitor” that can be charged using various techniques as would be appreciated by one of ordinary skill in the art having the benefit of this disclosure.

In one embodiment, the power section 216 may be considered self-contained as it may not be dependent upon a power supply wiring of a site at which the control device 200 is deployed. That is, in some embodiments, a control device 200 may be installed with mechanical fittings/connections and not a power supply wiring. In this way, in one embodiment, an electromechanical control section that receives control information via a wireless connection can control a pneumatic temperature controller, responsive to a mechanical input.

The pneumatic controller may receive an applied setpoint as a force and/or position, and in response, vary a gas pressure. The two-pipe pneumatic regulator section 202 may include a valve unit 206-10 that receives an inlet flow of a gas at a gas inlet 205-10 and provide an output flow at an outlet 205-11. In addition, a portion of an inlet flow may be applied to a flapper 206-11 by way of flapper input 206-14. In response to a control force (or position) provided by a ΔT displacer, the flapper 206-11 can vary a pressure at flapper output 206-15. A pressure at gas outlet 205-11 may vary in response to that at flapper output 206-15. In one embodiment, the ΔT displacer is a bimetallic strip 208. A bimetallic strip 208 may include two or more materials (in this case metals) having different thermal coefficients of expansion. Consequently, a control force/position output in response to a received applied setpoint may vary according to an ambient temperature of control device 200. In another embodiment, the ΔT displacer is a uni-metallic strip 218 as described in more detail below. A motor or “prime mover” is used for controlling the uni-metallic strip 218, which controls pressure, which controls the temperature. The uni-metallic strip 218 may translate an applied setpoint into a control force or position.

In the one-pipe pneumatic regulator section, the valve unit may receive an inlet flow of a gas at a gas flow inlet, and all or a portion of the inlet flow may be applied to a flapper by way of a flapper input. In response to a control force (or position) provided by a ΔT displacer, the flapper can vary an amount of inlet gas vented to another location (e.g., to the atmosphere). Thus, a pressure at the gas inlet may vary in response to a control force/position from the ΔT displacer, which is controlled by the electromechanical control section 204.

In another embodiment, the local sensing system 218 includes an occupancy sensing system and/or a temperature sensing system. The occupancy sensing system may provide data from which a determination may be made as whether or not a zone corresponding to control device 200 is to be considered occupied. Such a feature may allow HVAC power/resources to be conserved when a zone is not occupied. In response to requests from the deadband setpoint controller 210, a temperature sensing system may sense an ambient temperature of control device 200 (e.g., a zone temperature). Such a feature may allow control device 200 to be calibrated remotely when an applied setpoint does not correspond to a desired ambient temperature.

Conventionally, very few pneumatic thermostats have a mechanical override feature for after-hour occupancy, and none has the ability to automatically detect occupancy and adjust the zone setpoints accordingly, or influence the behavior of the HVAC system (e.g., boilers, chillers, fans, etc). The embodiments described herein provide various means to intelligently detect occupancy to modify its notion of occupied and unoccupied times that are normally based on a fixed schedule. The embodiments described herein can adjust its occupied/unoccupied state, setpoints, and even inform the main building automation system to take further action (e.g., boilers, chillers, fans, etc). In one embodiment, the WPT may include a motion sensor (e.g., a PIR detector, a sonar occupancy detector, a microwave occupancy detector, etc). In another embodiment, the WPT may include an ambient light sensor that can detect the presence of natural or artificial light as an indicator of human presence. This same sensor can additionally be used to intelligently detect bright sunlight as an indicator of a possible sudden heat load to compensate for temperature. For example, a sensor can be used to detect if direct sunlight is hitting the WPT, causing an artificially high temperature reading, so that the WPT doesn't over-cool the room, resulting in wasted energy. Alternatively, if sunlight entering the room causes a large spike in the load, the WPT can proactively cool the room to keep up with the rapidly changing load. The WPT may also using lighting heuristics to predictably heat/cool zones for the occupants. By logging the occupied times over the week, the zones could be pre-heated or cooled to add additional comfort to the occupant. This processing could be done on the thermostat, a stand-alone benefit, or by the server for networked devices. In another embodiment, the WPT can detect an unusual change in room temperature, for examples, caused by body heat of people in a conference room. The WPT can observe trends from any of these sensor inputs and can use processing logic to preemptively heat/cool an area based on occupant habits, instead of a fixed schedule. Based on repetitive manual adjustments from a tenant, the WPT can predicatively adjust the temperature setpoint beforehand for more comfort to avoid the manual input. The WPT may update a schedule according to any observed patterns from the scenarios described above to make any necessary adjustments, providing a robust and dynamic control system. In another embodiment, for more optimized energy usage, the system may slowly back off the temperature over a period of days or weeks until the tenant interacts with the pneumatic thermostat, indicating that they have reached their comfort limit. These occupancy detection embodiments can be used to optimize energy usage and comfort tradeoff. These embodiments may intelligently enable, disable, or adjust HVAC based on detected occupancy or vacancy.

In other embodiments, the WPT can include thermostat environmental intelligence and control. For example, other sensor and controls can be added to the WPT to provide a greater wealth of information to the server and to provide a higher degree of comfort to the user while saving energy. Conventional pneumatic thermostats are not capable of supporting these features. In one embodiment, this sensor information and control can be handled locally in the controller at each WPT, or it can be communicated to/from the system server/controller for remote control. The controller can also interface to other building automation systems through the BACnet protocol, or other communication protocols.

For example, for CO₂ sensor integration, the WPT can monitor the zone CO₂ to make intelligent decisions based on needs, for example, to bring in fresh air. Since the outside air might be at different temperatures, this often wastes energy. In another embodiment, including a CO₂ sensor in several or all WPTs in a system may provide an easy and cost-effective method for monitoring the entire building without adding separate wired or wireless sensor units. The system may send a wireless signal to an electro-pneumatic damper controller (or similar) to adjust the fresh air intake.

For another example, humidity sensors could be included in the WPT so that the server can determine on a per-zone basis when a humidifier or de-humidifier needs to run. Even if the system does not have the ability to control the humidity on a zone-by-zone basis, the information could drive the decision for the building as a whole by relaying it back through the server and to the automation system that controls the humidity. Conventional pneumatic stats have no ability to manage humidity.

In addition, electromechanical control section 204 may include a manual interface that can enable a user to manually enter data values, such as setpoint values. This can enable local control of control device 200, which may be selectively overridden by electromechanical control section 204.

In another embodiment, the pneumatic controller 202 may include a pneumatic output driver disposed between the valve unit 206-10 and the flapper 206-11. The pneumatic output driver may include a nozzle for controlling or establishing a pressure applied to flapper 206-11 at flapper input 206-14.

In one embodiment, the deadband setpoint controller 210 is a microcontroller. In another embodiment, the deadband setpoint controller 210 is a microprocessor. In one embodiment, the deadband setpoint controller 210 is the PSoC® processing device, developed by Cypress Semiconductor Corporation of San Jose, Calif., U.S.A. Alternatively, the deadband setpoint controller 210 may be other types of processing devices as would be appreciated by one of ordinary skill in the art having the benefit of this disclosure, such as, for examples, a processor having a ARM architecture, a PIC microcontroller manufactured by Microchip Technology Inc., of Chandler, Ariz., U.S.A., or other microcontrollers, such as those based on the 8051 architecture developed by Intel Corporation. The electromechanical control section 204 may also include memory. The memory may store instructions for execution by the deadband setpoint controller 210 for executing any of: setpoint deadband supervisory functions, diagnostic functions, or calibrations described herein, or equivalents. The memory may be volatile and/or nonvolatile memory, and in some embodiments may include nonvolatile memory for storing routines and configuration parameters.

In one embodiment, the deadband setpoint controller 210 simulates deadband behavior, by using a motorized electro-pneumatic (E/P) control to track the ambient temperature in the deadband range. In one embodiment, the deadband setpoint controller 210 can use the motorized cam mechanisms 222, which is coupled to the conventional pneumatic thermostat's setpoint control arm, such as described in U.S. Patent Publication No. 2009/0192653, filed Dec. 22, 2008. When the ambient temperature is within the specified deadband temperature span, then the deadband setpoint controller 210 uses the motorized cam to adjust the control arm's position in order to maintain a neutral output pressure (one where no heating or cooling takes place) (e.g., 8 psi). When the ambient temperature exists the deadband, the deadband setpoint controller 210 stops tracking the temperature (i.e., stops moving the motor) to regain the normal thermostat behavior outside of the deadband, allowing the normal temperature/pressure feedback system of the thermostat (e.g., bi-metallic element) to control the HVAC system. In one embodiment, the deadband setpoint controller 210 can use hysteresis for transitioning in and out of the deadband. In one embodiment, the hysteresis window can be asymmetric; for example, entering the deadband span can occur with less hysteresis while exiting occurs with more hysteresis. In another embodiment, the deadband setpoint controller 210 can minimize motor movements, and thus, optimize power, by keeping track of prior correction step sizes and learning the optimal step size for a given ambient temperature change.

In other embodiments, other E/P control options can be used to provide deadband functionality as described herein. The deadband setpoint controller 210 can control the temperature/pressure curve to provide the deadband range. The deadband setpoint controller 210 can customize the temperature/pressure curve. For example, in one embodiment, a Software Implemented Proportional, Integral, Derivative (PID) Control loop with all or any subset of the control components can be used to accurately regulate pressure using any of the methods described herein.

In another embodiment, the deadband control functionality may be achieved using a fixed pressure regulator and a pneumatic value or solenoid, as illustrated in FIG. 2B. FIG. 2B shows a block schematic diagram of a two-pipe fixed regulator E/P concept 250 according to one embodiment. Instead of using the cam motor to track ambient temperature within the deadband span (in order to provide idle branch pressure output of 8 psi), the deadband setpoint controller 210 controls a pneumatic solenoid valve 250 and a fixed regulator 254 (e.g., fixed 8 psi regulator). When the deadband setpoint controller 210 detects that the ambient temperature is within the deadband range, the deadband setpoint controller 210 actuates the solenoid 250 (or latching solenoid) in order to bypass the normal pressure control and guarantee a steady branch pressure (e.g., 8 psi). In one embodiment, the deadband setpoint controller 210 sends a selector signal to the solenoid 250. When the ambient temperature exits the deadband range, then the deadband setpoint controller 210 would simply move the cam to the heating or cooling setpoint and turn off the bypass solenoid 250 in order to resume normal thermostatic control outside of the span. This solution may be more power efficient because it avoids multiple motor movements within the deadband span. This solution, however, may add some cost and size to the pneumatic thermostat with the addition of the solenoid 250 and the regulator 254. In another embodiment, the pneumatic thermostat also includes additional fixed regulators set for other pressures, such as fixed regulator 252 (e.g., 5 psi) and fixed regulator 256 (e.g., 11 psi). This may facilitate a simple head/cool/off control that is low cost, reliable, and consumer very little power. In another embodiment, the valve 250 selects a path to the fixed regulator when the ambient temperature is inside the deadband range. No energy is used by the pneumatic thermostat to maintain constant pressure inside the deadband.

FIG. 2C shows a block schematic diagram of a one-pipe E/P concept 270 having selectable, fixed-size orifices to set desired pressure according to one embodiment. In this embodiment, the deadband setpoint controller 210 controls multiple pneumatic solenoids 272. Each pneumatic solenoid 272 corresponds to one of multiple fixed-size orifices 274. In this embodiment, the fixed-size orifices 274 have the following sizes: 0.001″, 0.002″, 0.004″, and 0.008″. Although the number of orifices and the sizes of those orifices may vary depending on the design considerations of the system. The deadband setpoint controller 210 can selectively control the combination of pneumatic solenoids 272 and fixed-size orifices 274 to control how much a received gas is vented (e.g., to the atmosphere) via the vents 276, thereby generating a backpressure at gas flow inlet 205-10 that may be used as a control value (e.g., 206-10) for other pneumatic equipment.

FIG. 2D shows a block schematic diagram of one-pipe 280 and two-pipe 290 pneumatic switch concepts according to two embodiments. The embodiments in FIG. 2D are similar to the embodiments of FIG. 2A, except where noted by reference labels. In particular, instead of bimetallic strip 208 or uni-metallic strip 218, the pneumatic controller 202-0 and 202-1 each has the ΔT displacer 208. The one-pipe configuration 280 includes a valve unit 206-00 that receives an inlet flow of a gas at a gas flow inlet 205-0, and all or a portion of the inlet flow may be applied to a flapper 206-1 by way of a flapper input 206-04. In response to a control force (or position) provided by the ΔT displacer 208, the flapper 206-01 can vary an amount of inlet gas vented to another location (e.g., to the atmosphere).

In addition, the one-pipe configuration 280 includes a pneumatic switch A/B 282 between the gas flow inlet 205-0 and the valve unit 206-00. The deadband setpoint controller 210 controls the pneumatic switch A/B 282 to vary the amount of inlet gas vented to another location via a fixed orifice 280. In one embodiment, the deadband setpoint controller 210 sends a control signal 283 to the pneumatic switch 282. Similarly, in another embodiment of the two-pipe configuration 290, a pneumatic switch 292 is disposed between the gas outlet 205-11 of the valve unit 206-00 and a gas outlet 205-12. The pneumatic switch 292 is configured to receive an input pressure from a fixed regulator 294, which allows some or all of the gas pressure at inlet 205-10 to pass through the pneumatic switch 292 instead of the valve unit 206-00. In one embodiment, the deadband setpoint controller 210 sends a control signal 293 to the pneumatic switch 292. The deadband setpoint controller 210, using the pneumatic switches 282 and 292 can bypass the valve unit to maintain a constant pressure while the ambient temperature is within the deadband. In one embodiment, a fixed regulator 294 (e.g., 8 psi) on the branch line can be switched in an out by latching the two-way pneumatic solenoid valve (e.g., pneumatic switch 292). Similarly, the fixed orifice 280 can be switched in and out of the main line 205-0 to maintain a constant pressure while the ambient temperature is within the deadband. These techniques may provide guaranteed flat deadband response without consuming energy for the control.

As described herein, a remote server can be used to remotely monitor and control the electromechanical section 204. In one embodiment, the remote server can monitor pneumatic deadband thermostats. In these embodiments, the remote server, using the deadband setpoint controller 210, can monitor zone conditions remotely, log data, send alerts, etc. In another embodiment, the server (or the controller 210) can determine additional energy savings by using the new deadband functionality by observing zone temperature and pressure data to determine heating/cooling load. In another embodiment, the server can remotely control the deadband pneumatic thermostats, either via a wired connection or a wireless connection. The server, for example, can specify the heating and cooling setpoints, occupancy mode, and override mode. Alternatively, these settings can be done locally at the deadband pneumatic thermostat.

In another embodiment, the remote server (or the deadband setpoint controller 210) can dynamically adjust the deadband range. For example, the deadband setpoint controller 210 can set the deadband according to a schedule that is managed locally or one that is managed by the remote server. The schedule may be a night setback schedule, a seasonal schedule, a weekend or weekday schedule, or the like. In one embodiment, the deadband could be set narrow during the daytime for maximum comfort and then widened during the nighttime to save energy, for example.

In other embodiments, the deadband setpoint controller 210 can automatically and dynamically calibrate the setpoints of the deadband. In one embodiment, the deadband setpoint controller 210 uses the branch pressure, ambient pressure, and cam position, to calibrate the deadband dynamically (as well as other setpoints). Based on the calibration, the deadband setpoint controller 210 can adjust the lever arm setpoint of the pneumatic controller of the thermostat. After the temperature has stabilized for some time, and the pressure is near the neutral output pressure or control pressure of the HVAC system, the current cam position can be recorded by the deadband setpoint controller 210 to indicate the accurate setpoint location of the current temperature. In one embodiment, the deadband setpoint controller 210 uses algorithms to detect pressure and temperature stabilization. Pressure stabilization can be detected after N consecutive readings inside a window of +/−P PSI around the control or neutral output pressure. N can be a value based on time. P can be some value equal to or greater than zero. Temperature stabilization can be detected after N consecutive readings inside a window of +/−T Degrees around the reference temperature, where T can be some value equal to or greater than 0. N can be a value based on time. The reference temperature can be the current temperature at a pressure or temperature stabilization failure. The reference temperature can also be a sliding window average of temperatures. In another embodiment, a look up table can be used to hold the accurate setpoint location for each setpoint available to the user. The index of the table can be the temperature value with or without an offset. In this embodiment, the deadband setpoint controller 210 can record the accurate setpoint location into a lookup table. The value can overwrite the current table setting. The value may be averaged into the current setting of the table. This can happen indefinably, for a fixed time frame then reset, or in a sliding window fashion. The value can also adjust neighboring setpoint settings in the table. For example if the accurate setpoint of the neighbors have not yet been filled, they can be set with the same or proportional value. Alternatively, if the neighbors are set the current value can have a proportional affect on them to make a slight adjustment. In another embodiment, if the cam/level arm location is linearly proportional to the setpoint, a gain and offset value can be created and used to position the motor. If two or more temperature and pressure stabilization regions are recorded at different temperatures, the gain and offset can be calculated using a two-point calibration method.

In another embodiment, the deadband setpoint controller 210 can also automatically and dynamically calibrate the setpoints outside of the deadband temperature range. The same calibration process used within the deadband range may also be used when outside the deadband range. It should be noted that the deadband setpoint controller 210 can calibrate all setpoints, not just the deadband setpoints.

In another embodiment, the deadband setpoint controller 210 can automatically calibrate a bimetallic strip response to temperature within the deadband range. When regulating the pressure to maintain a neutral output pressure, the deadband setpoint controller 210 can move the cam drive mechanism an amount proportional to the difference between the current pressure and the control pressure. In a perfect system, the pressure would return to neutral. However, to compensate for errors and variations between products, the amount to move the cam drive mechanism can be calibrated dynamically by the deadband setpoint controller 210. In one embodiment, the deadband setpoint controller 210 reads the pressure, moves the position of the control arm of the pneumatic controller by a known distance by the cam drive mechanism, and then reads the pressure again for a second time. The second pressure reading can occur after a fixed-time delay to allow the pressure to stabilize. The deadband setpoint controller 210 can record the difference in pressure with respect to the distance moved by the cam drive mechanism as a new gain factor in terms of Delta Pressure/Cam Offset. The gain factor may be overwritten at every sample, and may be averaged over time. A look up table can be used to maintain the cam offset for any given pressure difference. This will account for any non-linearity in the function.

In some situations, it is desirable to provide the maximum temperature control range with good accuracy. This often requires mechanical calibration when working with a pneumatic system. Conventional pneumatic thermostats have a setscrew or similar mechanism to calibrate the pressure to setpoint-temperature relationship. This is done by setting the setpoint to match the ambient temperature, and then adjusting the screw until the pressure output reaches idle (typically 8 or 9 psi). In one embodiment, the deadband setpoint controller 210 is configured to use a similar mechanism for basic mechanical calibration. In one embodiment, the deadband setpoint controller 210 operates in an enhanced mode that makes the process quicker and easier, and less prone to errors than the conventional process. In the enhanced mode, the deadband setpoint controller 210 uses a “tracking” calibration mode. In the tracking calibration mode, the deadband setpoint controller 210 controls the cam motor to automatically track the ambient temperature in order to allow screw adjustments for defining idle pressure. The user no longer has to manually change the setpoint to match ambient, and hope that it is accurate and stable during the calibration process. Doing this process manually is normally the cause of calibration errors. It should be noted that this enhanced mode can be used for non-deadband controllers of pneumatic thermostats, but may be ideal for calibrating the deadband pneumatic thermostat, since the traditional method of matching setpoint to ambient temperature is even more complex when the calibrating with a deadband. When matching setpoints to ambient temperature for deadband applications, the deadband span would either have to be zeroed, or moved out of the way of the current ambient temperature.

In another embodiment, the control device 200 includes a wireless temperature sensor that can be attached to an HVAC vent, as described herein, such as using a clamp. The wireless temperature sensor communicates with the deadband setpoint controller 210 to allow the deadband setpoint controller 210 to intelligently adjust the control pressure, in case the control pressure was set wrong, or if the control pressure drifts over time. This may prevent the temperature from being pegged at either the high or low deadband extreme. In other embodiments, the deadband setpoint controller 210 may determine the outside temperature or temperature of neighboring zones when needed using other techniques as would be appreciated by one of ordinary skill in the art having the benefit of this disclosure.

Described herein are various Electro-Pneumatic (E/P) solutions for controlling pressure based on temperature for use in an intelligent electro-pneumatic thermostat. These direct electro-pneumatic controls can be used for drop-in replacements of existing pneumatic HVAC thermostats. These E/P solutions can emulate the behavior of multiple different types of conventional pneumatic thermostats using only a single unit, which saves manufacturing cost and inventory cost. For example, one-pipe, two-pipe, summer/winter, day/night, reverse-acting, direct-acting, deadband can all be emulated with a direct E/P control, which would not be limited by bi-metallic strip's properties. The E/P solutions may create a desired branch pressure based on the ambient and setpoint temperatures, in order to command the associated pneumatic HVAC control device. As described herein, in one embodiment, a conventional pneumatic thermostat can be modified with a uni-metallic compliant strip (spring-type mechanism) instead of a bi-metallic, temperature-sensitive strip. Then a motor and cam mechanism can be attached to the uni-metallic strip to directly control the branch pressure, similar to how the setpoint dial or slider works on conventional thermostats. This utilizes the same components of the conventional pneumatic thermostat, but allows a controller to direct the motor to specify the pressure control curve, instead of relying on the limited bi-metallic strip. The use of a very flexible uni-metallic strip allows precise control of the force against the orifice without requiring extremely high precision mechanics. This can be done for all types of pneumatic thermostats (e.g., direct, reverse, summer/winter, deadband, etc).

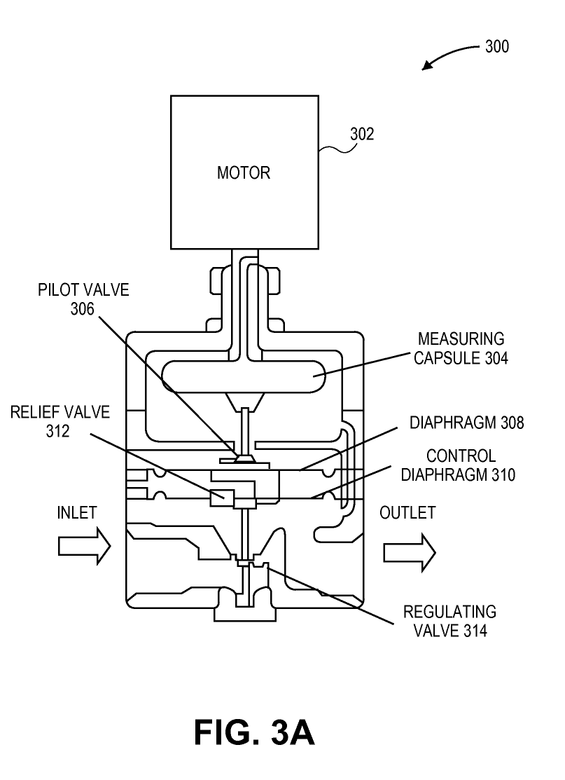

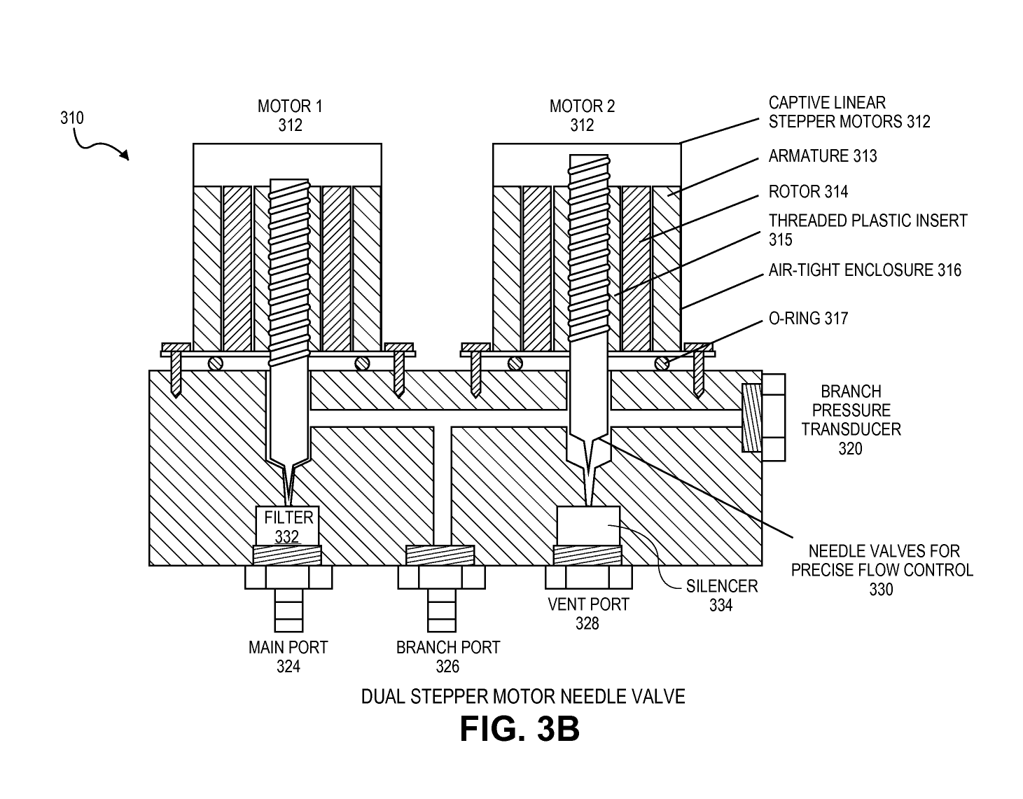

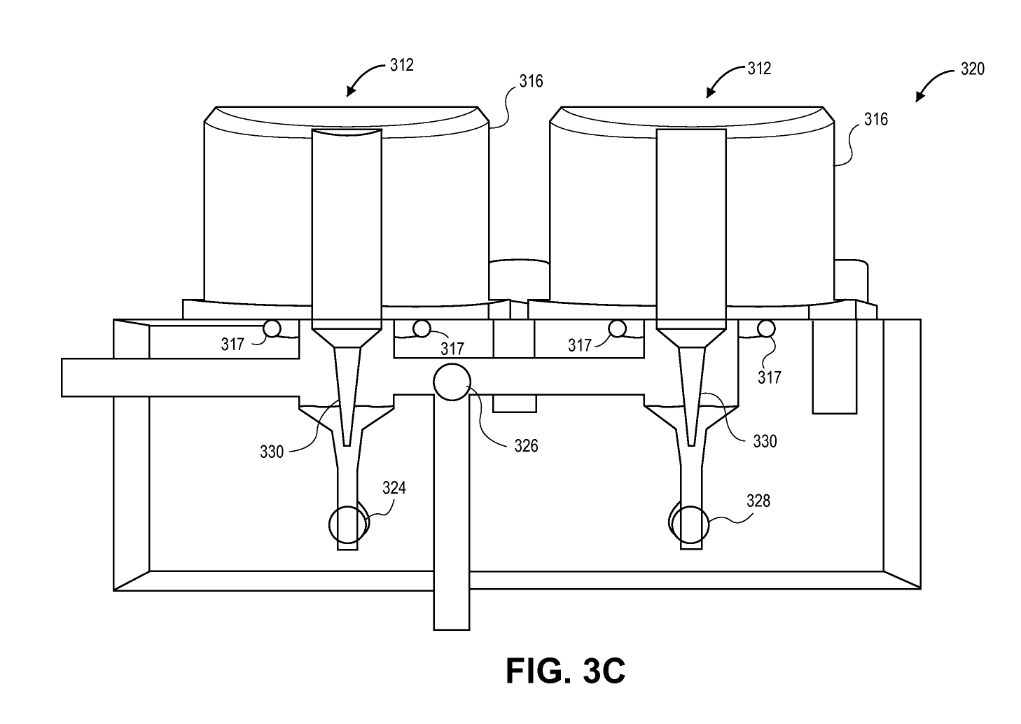

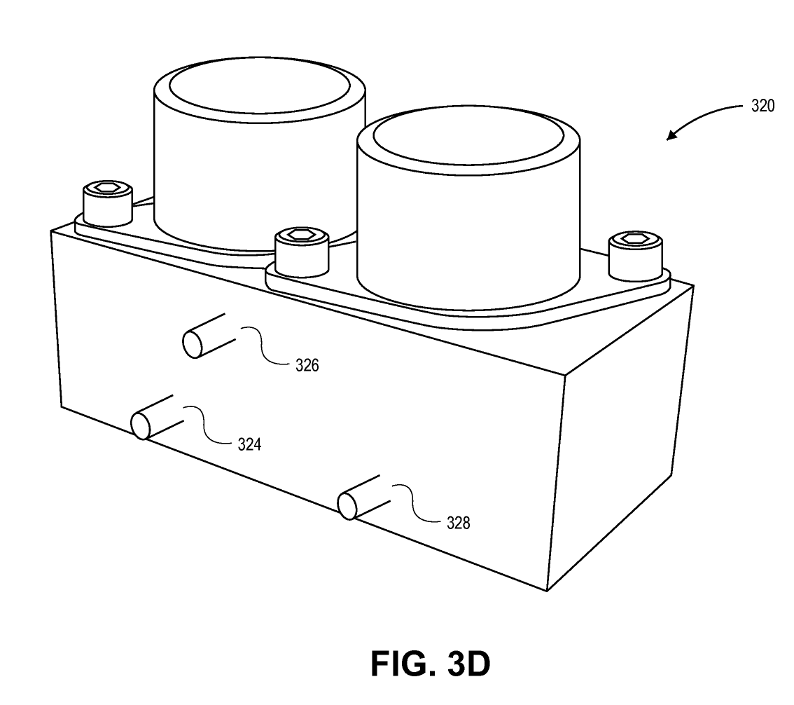

In another embodiment, a motorized pressure regulator can be used. In this embodiment, a stepper or servomotor is coupled via gears, belts, direct drive, or similar mechanisms to a conventional pressure valve. The motor can rotate the pressure valve knob to generate the desired pressure regulated output. In another embodiment, motorized need valves can be used, as described below in FIGS. 3B-3D. For example, a stepper or server motor can be coupled via gears, belts, direct drive, or similar mechanisms to a pneumatic flow valve/needle valve. The motor can rotate the valve to regulate the amount of airflow to increase the branch pressure or vent branch pressure. The dual needle valves can be used for two-pipe applications (to pressurize and vent), or a single motor with captive shaft that has needles on both ends of the shaft can be used. Unique needle taper profiles can be used to create the resolution needed and for burst modes.

In other embodiments, an E/P solenoid valve may be used to control the branch pressure. In other embodiments, a series of fixed-pressure regulators may be used with one or more latching E/P solenoid valves. The valves can be used to select the regulators to achieve the desired output pressure. MEMS valves may be used as described below. For example: for a simple control, three fixed regulators can be used, e.g., 3, 8, 13 psi, to provide full open, neutral, and full closed operation for the pneumatic actuator. For finer control, five regulators can be used, e.g., 3, 5, 8, 11, 13 psi to provide two medium settings. This may not require pressure feedback, since accurate regulators may be used. These embodiments may be tolerant to changes in main pressure, depending on the type of regulators used. In addition, these embodiments may be low power when latching solenoids are used.

FIG. 3A illustrates a motor-driven pressure regulator of a HVAC thermostat 300 according to one embodiment. The HVAC thermostat 300 includes a regulating valve 314 receives a control force from the deadband setpoint controller 210 as described above. In this embodiment, the regulating valve 314 is a motor-driven pressure regulator. The HVAC thermostat 300 includes a motor 302, a measuring capsule 304, a diaphragm 308, a control diaphragm 310, a relief valve 312, and a pilot valve 306. Although FIG. 3A illustrates the measuring capsule 304, diaphragm 308, control diaphragm 310, relief valve 312, and pilot valve 306, it should be noted that the motor-drive pressure regulator may be any type of pneumatic pressure regulator, for example, pneumatic pressure regulators used in 1-stage, 2-stage regulators, or the like as would be appreciated by one of ordinary skill in the art having the benefit of this disclosure.

FIGS. 3B-3D illustrate a dual stepper motor needle valve for a two-pipe pneumatic control device 310 according to one embodiment. The pneumatic control device 310 includes two motors 312, such as the two captive linear stepper motors illustrated in FIG. 3B. Each motor 312 includes an armature 313, a rotor 314, and a threaded plastic insert 315 within an airtight enclosure 316. Each motor 312 is mounted over an opening in an assembly in which a needle valve 330 may extend into a main port 324 and a vent port 328, respectively. O-rings 317 are placed around the openings of the assembly between the assembly and the motors 312. The deadband setpoint controller 210 can independently control the motors 312 for precise flow control of the main port 324 and the vent port 328. The assembly also includes a branch port 326, and a branch pressure transducer 320. In one embodiment, a filter 332 may be placed between the main port 324 and the opening in which the needle valve 330 is disposed. In another embodiment, a single motor needle valve may be used to control venting in a one-pipe pneumatic control device.

In some embodiments, a single motor can be used to drive two needle valves, even in a two-pipe application. A spool valve configuration with captive linear stepper motor may be used. The motorized needle valves can utilize special “burst” positions for high performance, such as for fast airflow, or for charging or venting to move the HVAC actuator quickly. The motorized needle valves provide burst positions with small movements, thus, saving power. The motorized needle valve embodiments may provide a simple, single model solution that can be used to replace all variants of existing mechanical pneumatic thermostats. These embodiments are reliable, low cost, low power, and provide precise flow control and high performance. The systems using the motorized needle valves can provide PID control, instead of only proportional control.

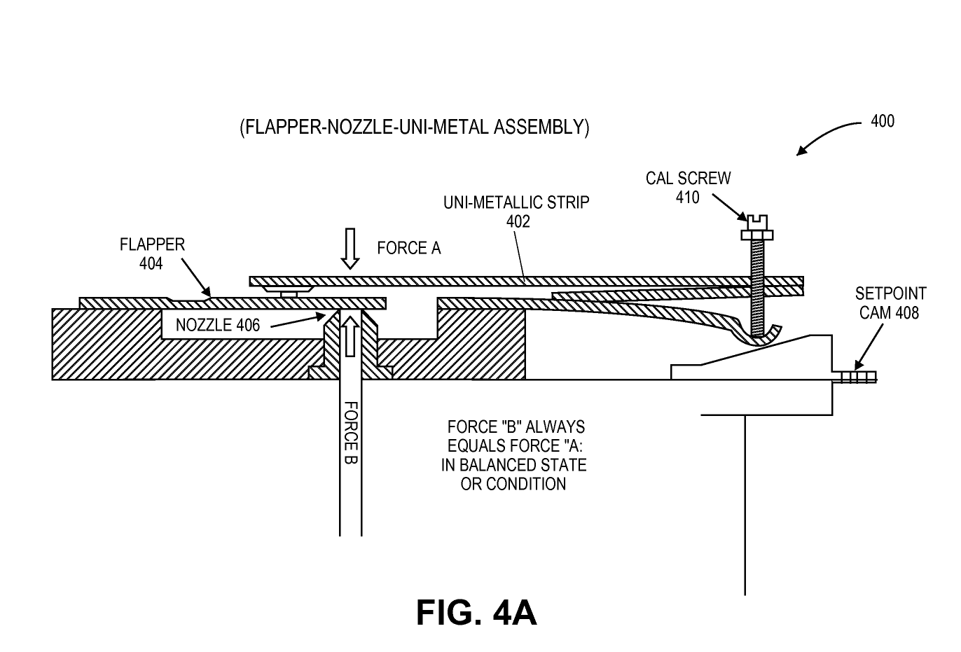

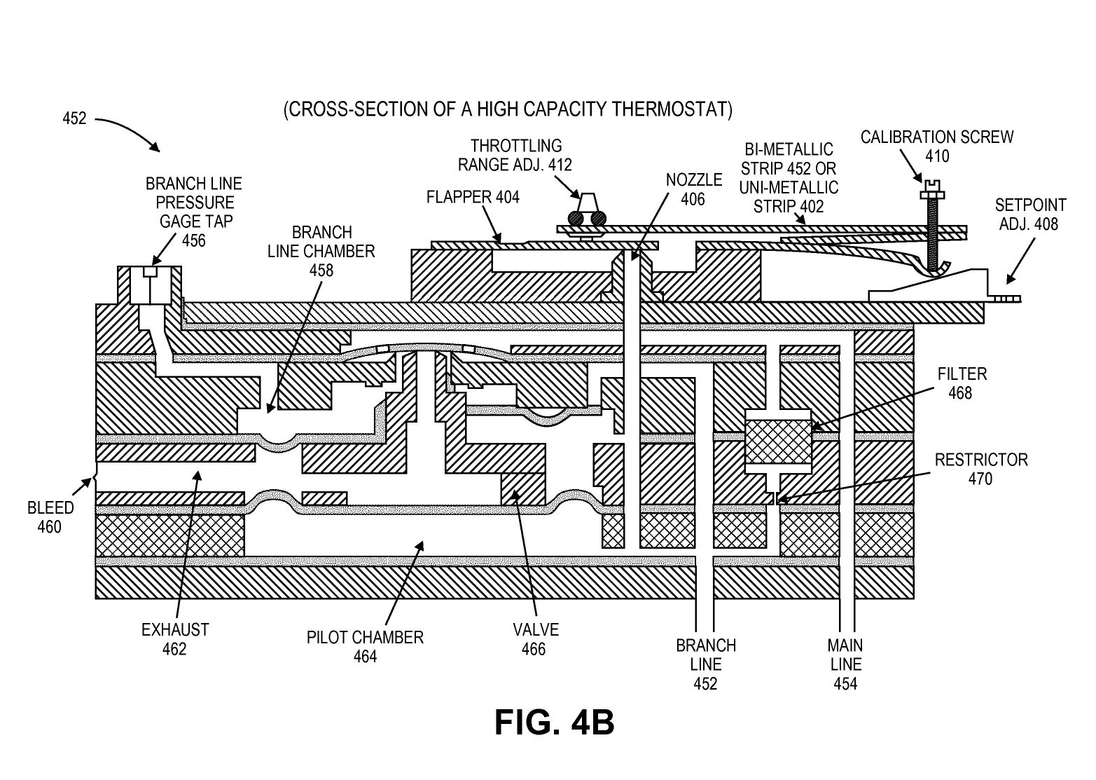

FIG. 4A illustrates a flapper-nozzle assembly 400 according to one embodiment. In this embodiment, the assembly 400 replaces a bi-metallic strip with the uni-metallic strip 402. Instead of letting the ambient temperature control the bend/pressure of the bi-metallic strip against the nozzle 406 to control air pressure, the deadband setpoint controller 210 uses a motor mated to the setpoint cam mechanism 408 (instead of a human finger) to select the desired uni-metal strip force to control the bend/pressure. The uni-metallic strip 402 may be a spring-type mechanism, and the motor and cam mechanism can select the desired pressure directly. The uni-metallic strip 402 can be used in an existing mechanical pneumatic thermostat, but allows the electronic control of the pressure response curve. The uni-metallic strip 402 can hold a fixed pressure with zero energy consumption. The assembly 400 also includes a calibration screw 410, and a flapper 404. In this embodiment, the force B on the nozzle 406 is always equal to the force A applied to the uni-metallic strip 402 in a balanced state or condition. The uni-metallic strip regulator can support all types of pneumatic thermostats with one or two different models, and provides a simple solution that is low cost, low power, and can be used for additional customization for pressure response curve, such as slope, deadband, etc. These systems can use PID control, instead of only proportional control. The use of the uni-metallic strip regulator may eliminate the need for a mechanical throttle range adjustment provision.

In another embodiment, a single bi-metallic strip can be used. The deadband setpoint controller 210 can use motor tracking to provide deadband control, dynamically sliding the second setpoint to the desired position. In another embodiment, two bi-metal strips can be used as in a conventional deadband pneumatic thermostat. This may be a lower power solution, since the motor tracking is not used during deadband, and no thermostat power is consumed within the deadband. In this embodiment, the deadband setpoint controller 210 can still dynamically control the deadband span by driving each setpoint cam mechanism independently.

FIG. 4B illustrates a cross-section of a high-capacity thermostat having the flapper-nozzle assembly of FIG. 4A according to one embodiment. The pneumatic thermostat 452 includes the assembly 400 of FIG. 4A as described above, as well as an assembly of an existing mechanical pneumatic thermostat. In one embodiment, the uni-metallic strip 402 is used. In another embodiment, the bi-metallic strip 452 is used. The pneumatic thermostat 452 includes a main line 454, a branch line 452, a branch line pressure gage tap 456, a branch line chamber, a filter 468, a restrictor 470, a valve 466, a pilot chamber 464, an exhaust 462, and a bleed 460 for venting the exhaust as controlled by the valve 466.

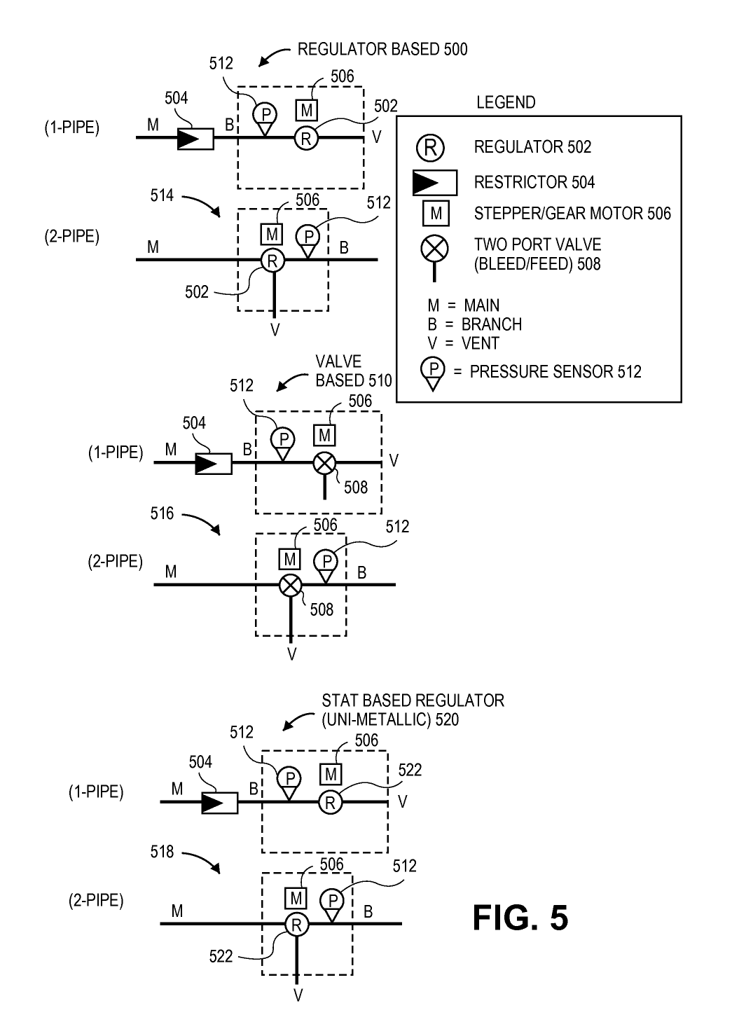

FIG. 5 illustrates schematic diagrams for regulator-based pneumatic controllers, valve-based pneumatic controllers, and stat-based pneumatic controllers for one-pipe and two-pipe applications according to various embodiments.

The one-pipe, regulator-based pneumatic controller 500 includes a pressure sensor 512 on the branch line before a motorized regulator 502, controlled by a motor 506 (e.g., stepper or gear motor). The motorized regulator 502 controls the amount of venting from the branch line. In this embodiment, a restrictor 504 may be placed in the main line to restrict flow into the pneumatic controller.

The two-pipe, regulator-based pneumatic controller 514 includes the motorized regulator 502 that receives the main line. The motorized regulator 502 controls the amount of venting from the main line and the flow/pressure into the branch line. The pressure sensor 512 is disposed on the branch line. In this embodiment, there is no restrictor 504 placed in the main line.

The one-pipe, valve-based pneumatic controller 510 includes the pressure sensor 512 on the branch line before a motorized two-port valve 508 (e.g., bleed/feed valve), which is controlled by the motor 506. The motorized two-port valve 508 controls the amount of venting from the branch line. In this embodiment, the restrictor 504 may be placed in the main line to restrict flow into the pneumatic controller.

The two-pipe, valve-based pneumatic controller 516 includes the motorized two-port valve 508 that receives the main line. The motorized two-port valve 508 controls the amount of venting from the main line and the flow/pressure into the branch line. The pressure sensor 512 is disposed on the branch line. In this embodiment, there is typically no restrictor 504 placed in the main line, in order to optimize thermostat response time.

The one-pipe, stat-based pneumatic controller 520 (e.g., uni-metallic strip pneumatic controller) includes the pressure sensor 512 on the branch line before a motorized stat-based regulator 522 (e.g., uni-metallic strip), which is controlled by the motor 506. The motorized stat-based regulator 522 controls the amount of venting from the branch line. In this embodiment, a restrictor 504 may be placed in the main line to restrict flow into the pneumatic controller.

The two-pipe, valve-based pneumatic controller 518 includes the motorized stat-based regulator 522 that receives the main line. The motorized stat-based regulator 522 controls the amount of venting from the main line and the flow/pressure into the branch line. The pressure sensor 512 is disposed on the branch line. In this embodiment, there is no restrictor 404 placed in the main line. As shown in these embodiments, for 2-pipe systems, the branch output is on the right; and for 1-pipe systems, there is only one pipe, so the system bleeds off pressure from that pipe so the pressure sensor is on the left side of it to sense branch pressure.

The following diagrams illustrate pneumatic thermostat architectures to support 1-pipe and 2-pipe applications, as well as proposed new pneumatic thermostat using E/P (Electro-Pneumatic) valves or MEMS pneumatic valves.

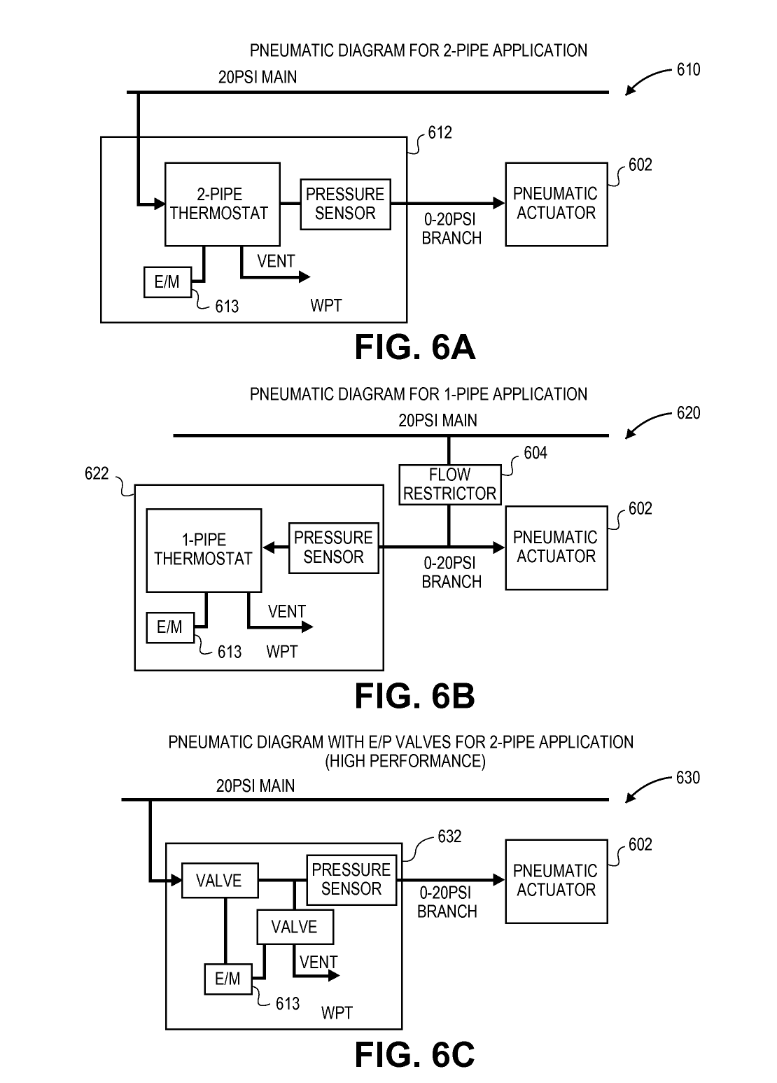

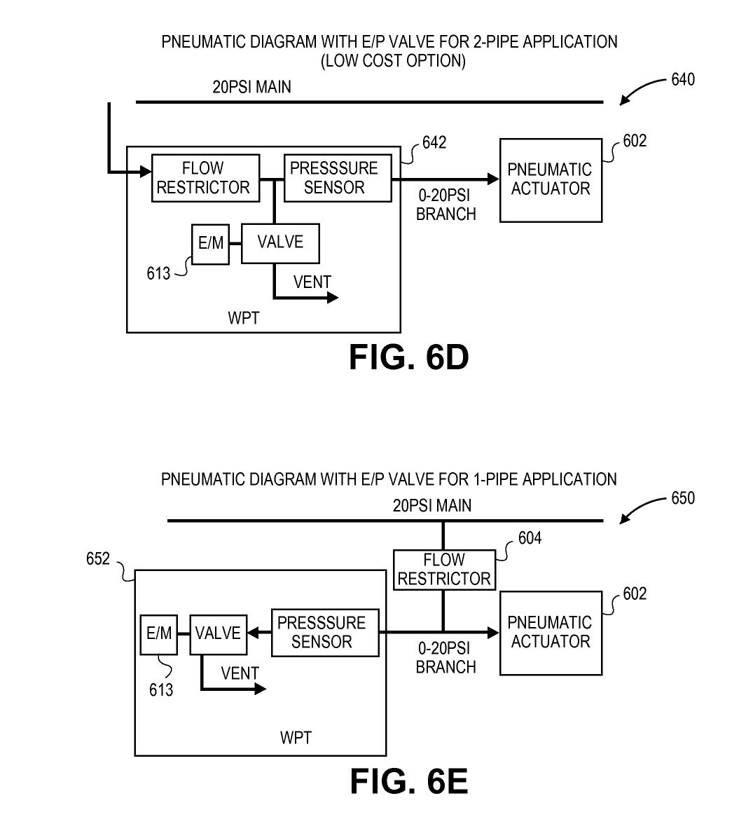

FIG. 6A illustrates a pneumatic diagram for a two-pipe application 610 according to one embodiment. The two-pipe application 610 includes a main line (e.g., 20 psi main) that is fed into a conventional 2-pipe pneumatic thermostat, which is controlled by a wireless pneumatic thermostat (WPT) 612. It should be noted that although the depicted embodiments illustrate the WPT 612, in other embodiments, other pneumatic thermostats as described herein may be used. In other words, the pneumatic thermostat does not necessary need to have a wireless communication circuit or a communication circuit, but could be a standalone pneumatic thermostat, a deadband pneumatic thermostat, or the like. The WPT 612, using an electro-mechanical component (E/M) 613, controls the 2-pipe thermostat to provide an appropriate branch pressure on a branch line (e.g., between 0 and 20 psi) to control a pneumatic actuator 602, such as an actuator of variable air volume (VAV) units, ventilators, fan coil units, reheat coils, radiators, and the like, typically employed in a heating, ventilation, and air conditioning (HVAC) systems.

FIG. 6B illustrates a pneumatic diagram for a one-pipe application 620 according to one embodiment. The one-pipe application 620 includes a main line (e.g., 20 psi main) that is fed into a flow restrictor 604, which controls the flow into a branch line. The branch line is fed into the 1-pipe thermostat and the pneumatic actuator 602. The branch line is controlled by the 1-pipe thermostat, which is controlled by the WPT 612. The WPT 612, using the E/M 613, controls the 1-pipe thermostat to provide an appropriate branch pressure on a branch line (e.g., between 0 and 20 psi) to control the pneumatic actuator 602.

FIG. 6C illustrates a pneumatic diagram with Electro-Pneumatic (E/P) valves for a two-pipe application 630 according to one embodiment. The two-pipe application 630 includes a main line (e.g., 20 psi main) that is fed into a first E/P valve that is controlled by the WPT 612. The output of the first E/P valve feeds the branch line. The WPT 612 also controls a second E/P valve that is connected to the branch line to vent the branch line as necessary. The WPT 612, using the E/M 613, controls the first and second E/P valves to provide an appropriate branch pressure on a branch line (e.g., between 0 and 20 psi) to control the pneumatic actuator 602.

FIG. 6D illustrates a pneumatic diagram with a single E/P valve for a two-pipe application 640 according to another embodiment. The two-pipe application 640 includes a main line (e.g., 20 psi main) that is fed into a flow restrictor. The output of the flow restrictor feeds the branch line. The WPT 612 also controls an EP valve that is connected to the branch line to vent the branch line as necessary. The WPT 612, using the E/M 613, controls the EP valve to provide an appropriate branch pressure on a branch line (e.g., between 0 and 20 psi) to control the pneumatic actuator 602. One advantage of this design may be that it is a single valve design, but this may be at the expense of response time.

FIG. 6E illustrates a pneumatic diagram with E/P valves for a one-pipe application 650 according to one embodiment. The one-pipe application 640 includes a main line (e.g., 20 psi main) that is fed into a flow restrictor 604, which controls the flow into a branch line. The branch line is fed into an EP valve, which is controlled by the WPT 612, and the pneumatic actuator 602. The WPT 612, using the E/M 613, controls the E/P valve (e.g., to vent the branch line) to provide an appropriate branch pressure on a branch line (e.g., between 0 and 20 psi) to control the pneumatic actuator 602.

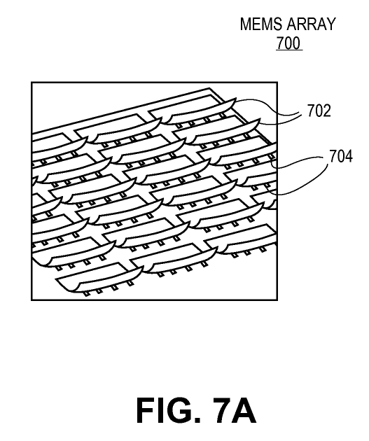

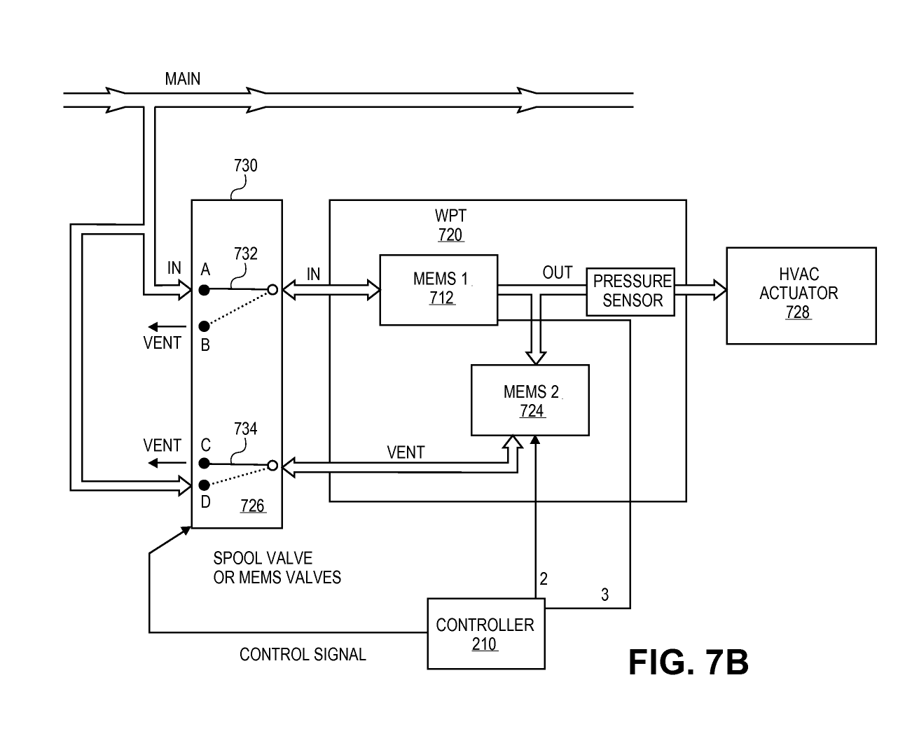

FIG. 7A illustrates a Microelectromechanical systems (MEMS) array 700 of electrostatic flappers covering a series of micro-orifices according to one embodiment. The MEMS array 700 is an array of orifices 704 that have a MEMS reed valve 702, such as a flapper or other slider to expose a tiny orifice, to allow or prevent airflow at the maximum required flow rate. The MEMS structures can be used to thermally or electro-statically actuate flappers/sliders for each orifice. The deadband setpoint controller 210 can control the MEMS valves using binary control, or using individually addressable micro-orifices to precisely control analog airflow.

FIG. 7B illustrates a MEMS valve-based pneumatic thermostat 720 according to one embodiment. The deadband setpoint controller 210 of the pneumatic thermostat 720 modulates the MEMS pneumatic valve 712 to provide the required airflow to maintain the desired branch pressure. The deadband setpoint controller 210 can also modulate a second MEMS pneumatic valve 724 to provide the required air venting to maintain the desired branch pressure. In one embodiment, the feedback for the modulation may be achieved through a pressure transducer on the branch line. The branch line pressure is used to control an HVAC actuator 728. The MEMS pneumatic valves may be advantageous because MEMS pneumatic valves are very small in comparison to other solutions, thus providing a smaller and lighter solution. MEMS pneumatic valves may also provide a very low power solution to actuate and hold the valve open, which supports longer battery life. In comparison, it is difficult to achieve a long battery life with conventional pneumatic relays for most reasonable sized batteries that would fit inside a thermostat and provide more than a year of battery life. In addition, MEMS pneumatic values may provide a quiet operation, which may be important in some environments.

In another embodiment, the MEMS pneumatic valve may have individually addressable orifices. Instead of actuating all MEMS reed valves (flappers or sliders), the deadband setpoint controller 210 can allow individual control for each micro-valve. This may provide very accurate flow control, smoother responses, and additional power savings since the entire valve does not have to be modulated.

Some MEMS valve designs may use an array of very small orifices, which may become clogged with dust over time. There are some processes to avoid dust clogging the MEMS valve to ensure long life in this HVAC application. In one embodiment, a finer particulate filter can be used than normally used for HVAC thermostats. In another embodiment, the deadband setpoint controller 210 can use one or more pneumatic solenoid valves to temporarily re-route airflow backwards through the MEMS valve device to clear out any dust or debris. The dust and debris can even be completely vented from the system.

FIG. 7C also depicts a MEMS anti-clogging solution. In this embodiment, the HVAC system has anti-clogging mechanism 730, having a first valve 732 and a second valve 734. The first and second valves may be solenoid valves that are controlled by the controller 210. The first and second valves may be spool valves, MEMS valves, or other valves as would be appreciated by one of ordinary skill in the art having the benefit of this disclosure. When the anti-clogging mechanism 730 is activated, the controller 210 controls the valves 732 and 734 to temporarily re-route airflow backwards through the MEMS valves 712 and 724. By temporarily re-routing the airflow backwards through the MEMS valves 712 and 724, the anti-clogging mechanism 730 can clear the MEMS valves 712 and 724 of any dust or debris. This process may be programmed to occur at a specified time, such as during the evening when the building is vacant or less populated, because this may cause a noticeable venting sound.

In another embodiment, the deadband setpoint controller 210 can open different sets of orifices of the MEMS valves 712 and 724 to achieve a proper ratio, such as using an intelligent algorithm. For example, if there are 20 rows of orifices, and one row needs to be open, then the deadband setpoint controller 210 could randomly select any row out of the 20, instead of always opening the first row. This may be done to help the first row, for example, from being clogged more rapidly than the remaining rows. In another embodiment, an electrostatic charge may be used to remove the dust/debris from the MEMS valves. For example, the overall MEMS device could be charged or a nearby metal surface in order to attract the dust/debris away from the MEMS orifices. Cleaning the dust collected on the electrostatic surface can be accomplished periodically, for example, using a brief jet of air from a pneumatic solenoid valve in the system, as controlled by the deadband setpoint controller 210.

In one embodiment, the assembly including MEMS valves 712 and 724 can be used as a drop-in replacement for a conventional mechanical pneumatic thermostat. Alternatively, a single MEMS valve may be used in lieu of a conventional bi-metallic strip in order to act as the pilot valve, and thereby control the pressure output of a conventional pneumatic thermostat controller. The MEMS valve embodiments may be very low power, small in size and weight, may have high reliability and high accuracy (e.g., precise airflow control), and may be the fewest moving parts design. The MEMS valve can be used with proportional-integral-derivative (PID) control, instead of just proportional. A thermostat utilizing one or more MEMS valves and an electronic controller can also be used as a single replacement part for all pneumatic thermostat variants (direct acting, reverse acting, deadband, summer/winter, etc).

In other embodiments, the pneumatic thermostat may be a standalone pneumatic thermostat that can be a drop-in replacement of any existing mechanical pneumatic thermostat. The standalone pneumatic thermostat may be similar to the pneumatic thermostats described above, but without a communication circuit or a wireless communication circuit. The standalone pneumatic thermostat may provide a low cost option for customers to incrementally improve energy consumption, since no infrastructure is needed. The standalone pneumatic thermostat may provide a digital display of ambient temperature, branch pressure, main pressure, setpoint temperature(s), time, day, and operating status. The standalone pneumatic thermostat may provide local scheduling control. For example, the standalone pneumatic thermostat may allow night setback and/or weekend/holiday setback and may provide schedule flexibility. For example, 7 day (each day of week contains a unique schedule), 5-1-1 day, 5-2 days, or 365 day (each day of year contains a unique schedule), or any other combination. The standalone pneumatic thermostat may provide different operating modes, such as Automatic/Run: Schedule controlled, Manual/Permanent/Hold: Manually controlled by user, and Temporary: Override. The standalone pneumatic thermostat may also provide intelligent occupancy control, such as using electronic sensors to detect occupancy in each zone. The standalone pneumatic thermostat may also provide local auto calibration for maintenance free operation, and may detect issues with mains supply, and. detect issues with HVAC system response to commanded pressure/temperature. The standalone pneumatic thermostat may also provide the ability to copy schedules to multiple devices for easier and faster installation and configuration. For example, an operator can program the master schedule on a device, such as a PC, and then can copy that schedule to the standalone pneumatic thermostat by using, for example, wireless communication, an infrared link, a cabled connection (e.g., USB connection to the PC), or a low-cost plug-in personality module or copying module, such as a small PCB with memory, connector, and possibly control logic.

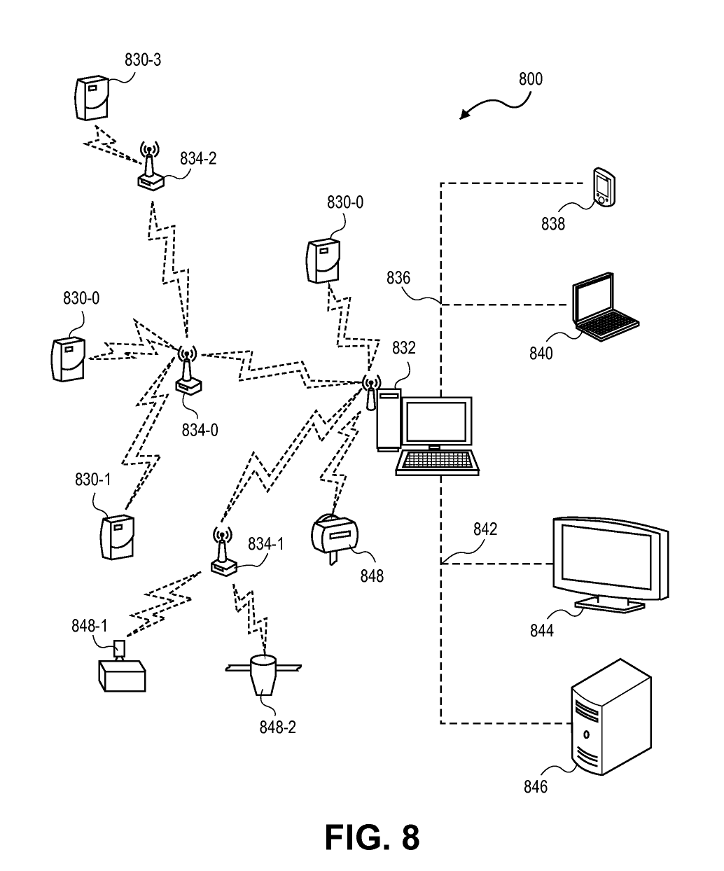

While the above embodiments have shown various control devices, alternate embodiments may include control systems. Examples of such systems are shown in FIG. 8. It is noted that while FIG. 8 shows an example of a wireless network, alternate embodiments may include wired connections between all or a portion of the system components.

Referring to FIG. 8, a system may include one or more control devices according to the embodiments described herein, or equivalents, and a master device. The particular embodiment of FIG. 8 includes four control devices 830-0 to 830-3, a master device 832, and a repeater 834-0. Control devices (830-0 to 830-3) may include any of the control devices shown herein, or equivalents, and in the particular embodiment of FIG. 8, may be wireless pneumatic thermostat (WPT) devices. Control devices (830-0 to 830-3) may receive data from (e.g., input setpoint data) and provide data to (e.g., ambient temperature, occupancy status, diagnoses of control device, or mechanical inputs to such control devices) master device 832 over a wireless connection.

A master device 832 may include a processor, and control and monitoring tools executable by such a processor. In the very particular example shown, a master device may be a personal computer, or equivalent, with a wireless transceiver.

Optionally, in the event a control device (830-0 to 830-3) is positioned outside of a direct wireless range with respect to master device 832, one or more repeaters may be included that may amplify and retransmit signals between a master device 832 and a control device. In the embodiment of FIG. 8, control device 830-0 may have a direct wireless connection with master device 832. In contrast, control devices 830-1 and 830-2 have a wireless connection with master device 832 through repeater 834-0. Multiple repeaters may be used to increase distance even further. In the example of FIG. 8, control device 830-3 may have a wireless connection with master device 832 through repeaters 834-2 and 834-0. In other embodiments, more than two repeaters may be used to connect a control device with a master device.

In this way, a network of control devices, such as wireless pneumatic thermostats may be monitored and/or controlled with master device over a direct wireless connection or through one or more signal repeaters.

In a particular embodiment, one or more other monitor/control devices may further access a master device 832. For example, a master device 832 may be connected to, and accessible from a network 836. Such a network may include a local area network or wide area network, as but two examples. In the particular embodiment shown, a handheld device 838, which may include a cell phone, and personal computer (e.g., laptop or desktop) 840 may access master device 832, and thereby control and/or monitor control devices (830-0 to 830-3). In addition or alternatively, a master device 832 may be connected by a communication path 842 to an Internet access device 844, or may be connected to a building management system 846. In such an arrangement, control devices (830-0 to 830-3) may be monitored and/or controlled by an Internet application (such as a World Wide Web service), or an existing building management system.

In a particular embodiment, a system 800 may include other wireless devices in addition to control devices (830-0 to 830-3). FIG. 8 shows other wireless devices 848-0 to 848-2 be connected to master device 832 directly, or by way of one or more repeaters (e.g., 834-1). As but a few examples, other wireless devices may include, but not be limited to, wireless gauge readers, wireless battery monitors, or wireless steam trap monitors.

In the case of a wireless network, communications between devices may be via a mesh network according to a suitable standard, including the CyFi™ standard, promulgated by Cypress Semiconductor Corporation, Wi-Fi, or ZigBee. A master device 832 may be a server running a Windows®, Linux type or other operating system, including SQL type applications. Further, such a server may include a BACnet type interface for communications with a BACnet type system.

While the embodiments may include devices and systems, other embodiments may include various methods.

Since most of these concepts depend on a controller to control the pressure in response to changing ambient temperature and/or setpoints, there needs to be considerations for failsafe operations if the power source drains (e.g., battery, solar, or other), or is removed. For some of the embodiments, the controller can detect a low battery level and then go into an idle mode where it sets the pressure control to a nominal setting (e.g., 8 or 9 psi) and then disabling itself. This may avoid constantly heating or cooling when the product battery dies. It can also intelligently determine the nominal setting pressure based on a history for that zone, helping the system stay in a comfortable range during occupied times. For example, when the failsafe is activated, the system may drive the system to the average recent pressure output (e.g., instead of 8 psi). In another embodiment, an internal fixed-pressure regulator (e.g., 8 psi) could be provided and activated by a latching solenoid in a failsafe condition to guarantee an idle output pressure. If the system is a heat-only or cool-only system, then the regulator may not be needed, since the device could simply actuate the pressure control to one or the other extreme (close or completely vent). In another embodiment when using MEMS, piezoelectric, and possibly other solutions, a backup power source (such as a coin-cell battery) can be used to hold the device in neutral failsafe mode for weeks, since it requires such little power, until the main battery is changed. Similarly, a backup battery or super-capacitors may be used as secondary power sources. In another embodiment, a solenoid valve can be used to switch to a bi-metallic control strip for backup when in a failsafe mode. In another embodiment, a server can control other pneumatic thermostats of neighboring zones to compensate for a failed pneumatic thermostat. In another embodiment, the processing logic can shut down other operations performed by the system, except the E/P control to preserve power for additional time. In another embodiment, solar cells may be used to provide secondary power for powering the E/P control indefinitely. In another embodiment, an analog circuit may be used with a temperature sensor in the feedback control loop for E/P control for low power continuous control without waking the microcontroller or CPU.

In other embodiments, a software PID control loop with all or any subset of the control components described herein can be used to accurately regulate pressure using any of the methods described herein.

Currently, mechanical pneumatic thermostats require periodic calibration to insure the branch pressure reads a specific value, typically 8 psi, when the setpoint equal the ambient temperature. As described herein, a controller of the WPT can use an intelligent algorithm to continually sample the branch pressure, ambient temperature, and device setpoint. The WPT can then compensate for any deviation from desired pressure, for example, by adjusting the cam movement (which affects the bi-metallic control element). The branch pressure can be monitored at one temperature while the setpoint is varied. The PSI vs. setpoint curve can be stored for future use. Throttle range changes may affect the PSI vs. setpoint response. One accurate way to insure the correct PSI output for a requested setpoint is to perform calibration after any throttle range adjustment as described above.

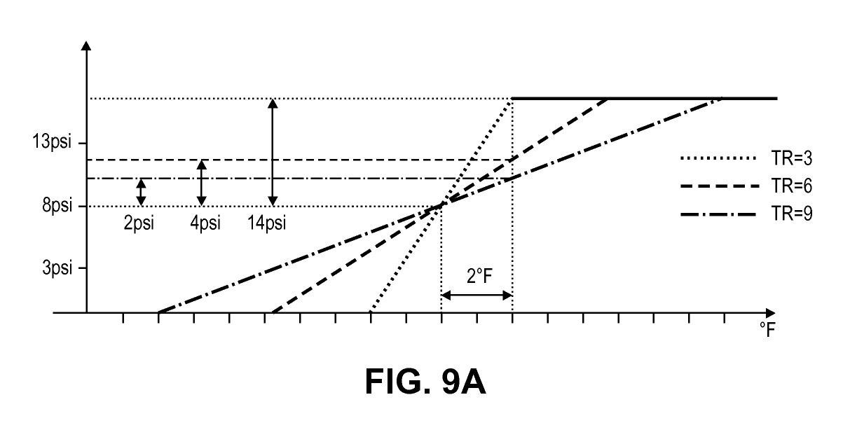

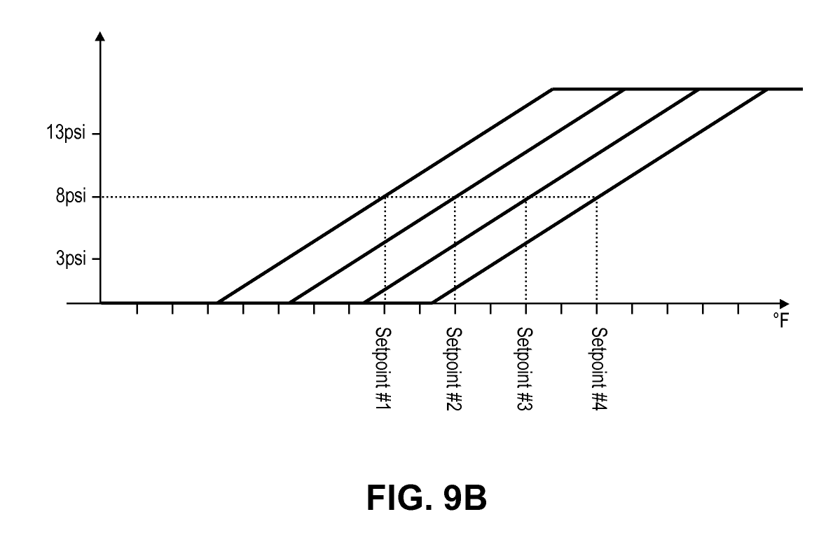

FIG. 9A is a graph of pressure and setpoint curves with different throttle range settings according to one embodiment. The setpoint curves of FIG. 9A show the output changes for a 2 degree Fahrenheit setpoint change (e.g., motor movement) with different throttle range (TR) settings. This calibration is conducted at a constant ambient temperature.

The setpoint can be recorded each time the branch pressure equals 8 psi for longer than a predefined number of samples (for example: samples=3). A running average of setpoint positions can be maintained to insure that that the correct setpoint position is used for each desired pressure temperature setting. This calibration method does not account for changes to the throttle range.

FIG. 9B is a graph of temperature and pressure curves at various setpoints according to one embodiment. FIG. 9B illustrates the Temperature vs. PSI curves at various setpoints. In this calibration scheme, the ambient and motor position are recorded when the output pressure equals 8 psi. Motor position information is then used to insure the setpoint equals the ambient temperature when the output is 8 psi.

This feedback calibration can ensure that the thermostat is functioning correctly independent of the air handler and dampers. This is similar to the type of calibration a technician would manually perform. This ensures the proper system feedback when the output pressure is calibrated to 8 psi when the setpoint=the ambient temperature, however, it does not ensure that the room temperature is equal to the setpoint.

In another embodiment, the WPT includes a one-touch calibration feature. This may be similar to the above, but the calibration is corrected by the motor position instead of the calibration screw. This one-touch calibration may be initiated by a menu in the system, or could be implemented as a button for which a cover would not have to be removed. This would allow the WPT to self-calibrate, removing the process of manually calibrating using a calibration screw. The one-touch calibration feature can be programmed to have a delay (e.g., 1 hour) to allow the thermostat to equilibrate. In another embodiment, if the motor has to move too much such that the desired dynamic range of the system is reduced, the user would be notified that a manual calibration is needed.

In another embodiment, the WPT can be calibrated using a system calibration feature. This calibration may not look at the branch pressure for accuracy, but assumes there could be inaccuracies with the thermostat, air supply, damper valve, HVAC system, or any or all of the above. The system calibration can be configured to continue to increases or decrease the branch pressure to drive the ambient temperature to the requested setpoint. This type of calibration could mask, temporarily, larger system problems, but the wireless control could also notify the system administrator if the calibration factor exceeded user defined limits. The system could also make suggestions on what could be failing, such as “Check for low main supply,” “Check damper for calibration,” or “HVAC supply to the room might be undersized.”

In another embodiment, the system includes a damper calibration. From the typical zone response over a period, the system could determine the minimum and maximum PSI for the heating and cooling dampers. These could be logged for each zone and reported to the maintenance staff for review. For example, the zone could start as 3-7 psi=heat, 9-13 psi=cool, but has shifted to 2-6 psi, 10-14 psi.

In another embodiment, the time required to charge up the load to a certain pressure can be calibrated. This may allow accurate prediction of opening an E/P valve to hit a desired pressure, instead of requiring tight closed-loop control. This may save power by avoiding extra pressure readings, may minimize movements/adjustments for long life, and may provide faster response times to reach control point.

In another embodiment, the throttle range may be an electronically variable throttle range. In this embodiment, the system can determine the throttle range required to get specific zones to the setpoint in the morning. For example, large rooms can automatically utilize a more aggressive throttle range to reach desired temperature at the same time as other zones if necessary.

In another embodiment, the WPT can include intelligent pre-heat control for a building based on all of the wireless temperatures from each zone. For example, a central controller looks at the temperature response of all zones to optimize the pre-heat or pre-cool. In another embodiment, neighboring zones can learn how much impact one has on the other, so that they are coordinated to avoid fighting each other.

In other embodiments, the WPT can include additional control outputs. In one embodiment, the addition of relays or solenoid valves (or similar types of outputs) to the WPT can allow the integration and control of different types of HVAC systems into one control system. This would be different from a wireless relay, since this would be a full functioning thermostat with or without the pneumatic hardware present in the WPT. The device could include some or all of the sensors mentioned previously (temperature, humidity, CO2, etc). For example, there may be a bank of one or more actuators. This would allow intelligent control based on sensor input, or scheduled control managed locally by the local controller or managed remotely by the wireless server. The maintenance personnel could program a schedule of on/off times on the WPT server or on the WPT device itself. The maintenance personnel could alternatively specify which sensors are associated with the control outputs, and define the control algorithm. The relays could be conventional or latching mechanical relays, or solid-state transistor based, depending on the load required, and the battery life impact tolerated. The latching relays may be ideal for battery-operated solutions.

There are many simple on-off heating and cooling devices existing in the field that do not have a means of integration of power savings. Often these units have low voltage (24V) remote thermostats for control. The system may include wall heater, window-mounted air conditioners, and packaged Terminal Air Conditioners (PTAC units). Many of these HVAC systems are constantly running and could benefit from the use of managed control. By replacing the existing stand-alone single zone thermostat with a wireless networked thermostat with a simple interface, a large energy savings could be realized per zone. Benefits may include ease of installation, integration into existing WPT RF network, centralized monitoring, scheduling and performance tracking, same common WEB interface for all HVAC zone management, familiar thermostat user interface. Higher voltage control applications include (which would require a properly sized relay or valve), for example, HVAC fans, Heating coils, Compressors, Boilers, Wall outlets (for plug-in appliances, like space heaters). These higher voltage control applications can be managed locally in the WPT's controller, or they can be remotely relayed from the server or another wireless sensor or node in the network. This is not possible in conventional pneumatic thermostats, so including this capability in a drop-in replacement pneumatic thermostat is very cost effective for both material and installation labor. The control device can also be a separate unit that has a dedicated function (such as wireless communication and relay only, to make it small and cost-effective). It still may be integrated seamlessly with the rest of the WPT monitoring and control system.

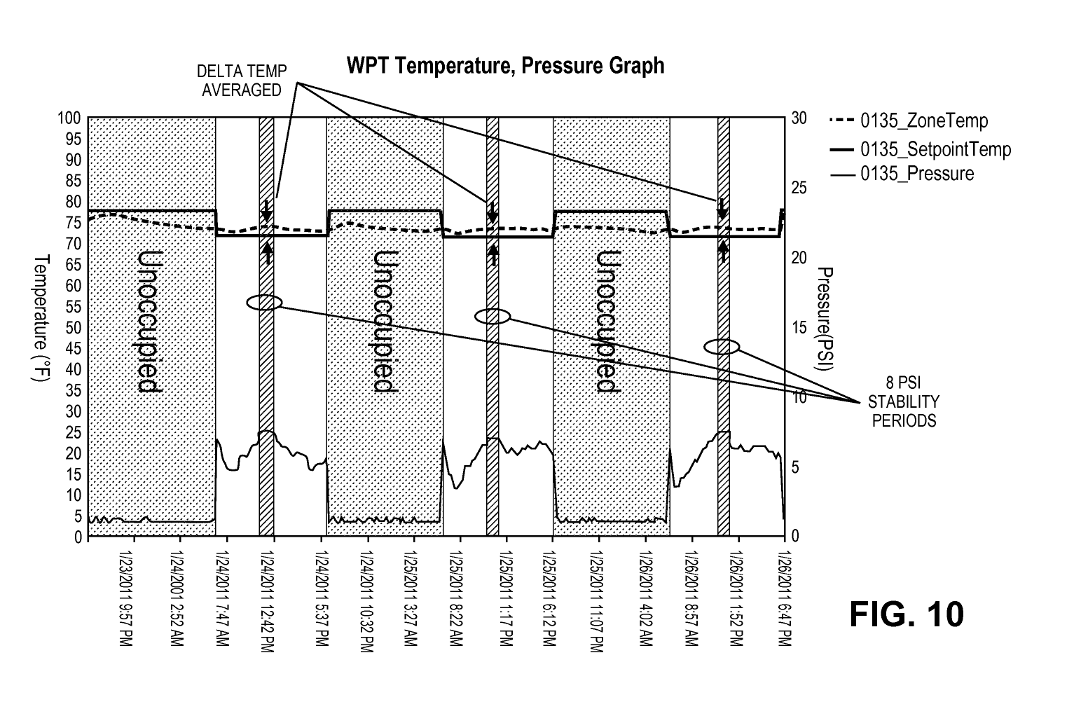

FIG. 10 is a temperature and pressure graph of a pneumatic thermostat, having an automatic calibration feature according to one embodiment. FIG. 10 shows a data log of ambient temperatures, setpoints, and pressures over several days. It highlights areas within the occupied times where the temperature and pressures are relatively stable, which then allows the algorithm to notice if there is an offset between ambient and setpoint temperature. It can then gather these data points to determine an automatic offset to apply.

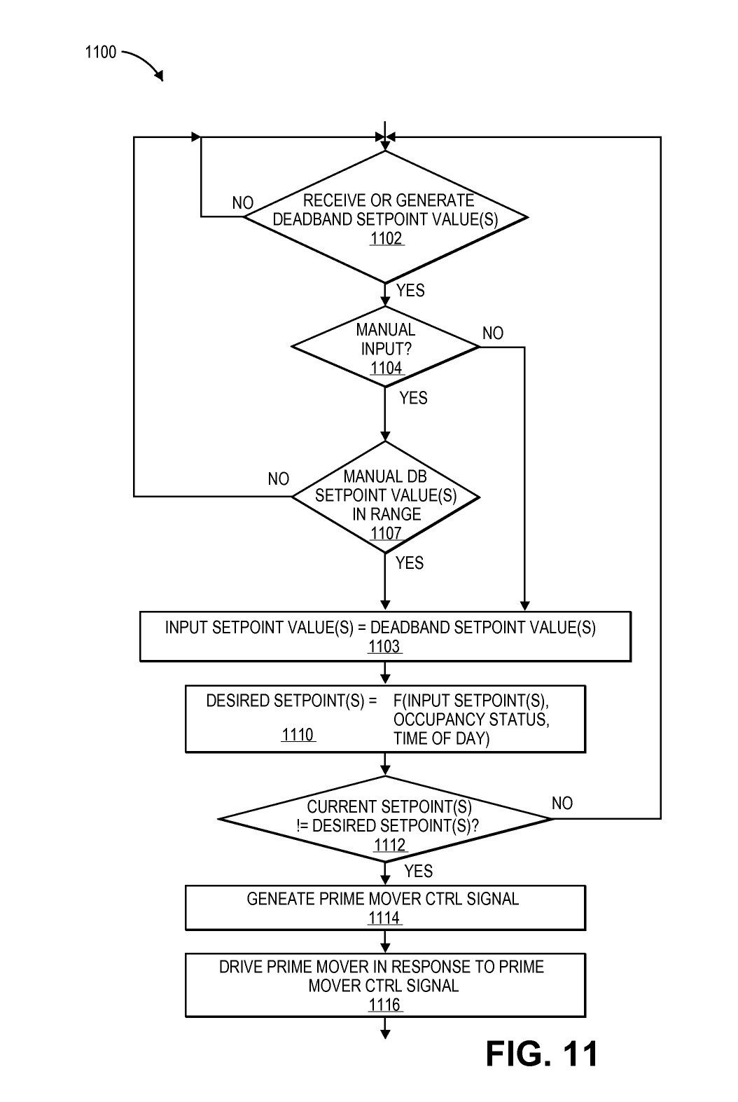

FIG. 11 is a flow diagram of one embodiment of a method 1100 for deadband control. In some embodiments, processing logic may be used to perform the method 1100. The processing logic may include hardware, software, or any combination thereof. In one embodiment, the controller 110, 210 performs the method 1100. Alternatively, other components may be used to perform some or all of the operations of the method 1100.

Referring to FIG. 11, a method according to a first embodiment is shown in flow diagram and designated by the general reference character 1100. A method 1100 may include determining if one or more deadband setpoint values are received via a wireless connection or generated by the controller (block 1102). In some embodiments, this may include receiving input setpoint values from a master device over a wireless connection either directly, or by way of one or more repeaters. In other embodiments, the processing logic generates the deadband setpoints based on a schedule, based on local data, or based on input received from a local user interface.

If deadband setpoint values have been received (Y from block 1102), a method 1100 may also include setting input setpoint value(s) to the received set point value(s) (block 1103). In this way, a setpoint for a control device may be set automatically.

The particular method 1100 also includes the ability to input deadband setpoints manually. Thus, if a manual input is received (Y from block 1104), such manual input deadband setpoint value(s) may be examined to determine if they are within an acceptable range (block 1107). If such values are within a range (Y from block 1107), the input set point value(s) may be updated to the manually input deadband setpoint value(s) (block 1103). If such values are not within a range (N from block 1107), such values are not utilized as the input deadband setpoint value(s), and the method returns to determine if deadband setpoint values have been received (at block 1102).

A method 1100 may generate a desired setpoint value (block 1110) based received deadband setpoint values (e.g., received wirelessly or entered manually). In the embodiment shown, a desired setpoint value may be function of any or all of: input setpoint value(s), an occupancy status, and/or a time of day.

If current setpoint value(s) are not equal to desired setpoint value(s) (Y from block 1112), a prime mover control signal may be generated (block 1114). A prime mover position may be moved in response to the prime mover control signal (block 1116).

In this way, a method may cause prime mover to induce a mechanical action in response to deadband setpoint values.

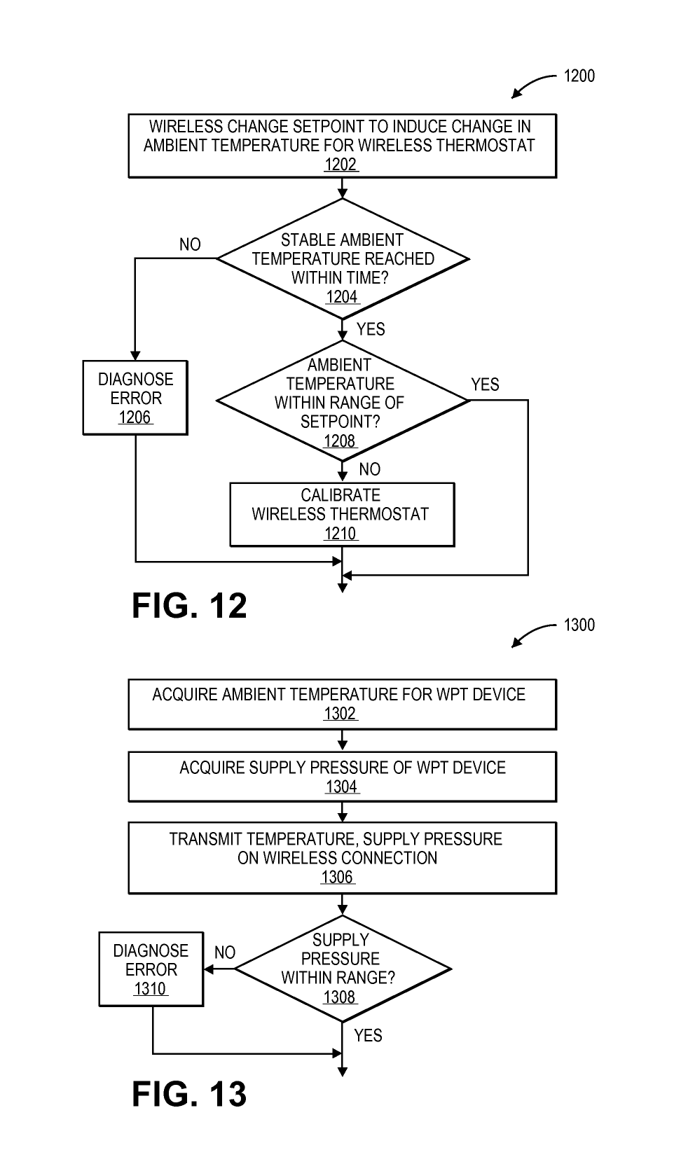

Referring now to FIG. 12, a method according to another embodiment is shown in a flow diagram and designated by the general reference character 1200. In some embodiments, processing logic may be used to perform the method 1200. The processing logic may include hardware, software, or any combination thereof. In one embodiment, the controller 110, 210 performs the method 1200. Alternatively, other components may be used to perform some or all of the operations of the method 1200.

A method 1200 may include wirelessly changing a setpoint value to induce a change in ambient temperature for a wireless thermostat (block 1202). If a stable ambient temperature is not reached in time (N from block 1204), an error may be diagnosed (block 1206). If a stable ambient temperature is reached within a period (Y from block 1204), an ambient temperature may be checked to determine if it is within a range of the setpoint (block 1206). If an ambient temperature is not within range of a setpoint (N from block 1208), the wireless thermostat may be calibrated (block 1210). In this way, a wireless thermostat may diagnose errors and calibrate itself.

Referring to FIG. 13, a method according to another embodiment is shown a flow diagram and designated by the general reference character 1300. In some embodiments, processing logic may be used to perform the method 1300. The processing logic may include hardware, software, or any combination thereof. In one embodiment, the controller 110, 210 performs the method 1300. Alternatively, other components may be used to perform some or all of the operations of the method 1300.

A method 1300 may include acquiring an ambient temperature for a wireless pneumatic thermostat (WPT) device (block 1302). A supply pressure for a WPT device may then be acquired (block 1304). Such actions may include sensing systems of the WPT device determining the ambient temperature and a pressure of a gas supplied to the WPT device. A method 1300 may also include transmitting temperature and supply pressure values on a wireless connection (block 1306).

In the particular method 1300 shown in FIG. 13, a supply pressure value may then be utilized to diagnose an error. If a supply pressure is not within a range (N block 1308), an error may be diagnosed (block 1310). Such an action may include a master device comparing a received supply pressure value to predetermined limit(s). Alternatively, such a determination may be made within a WPT device, such as with a controller circuit, as but one example. In this way, a wireless pneumatic thermostat may wireless transmit data including an ambient temperature and a supply pressure. A supply pressure value may be used to diagnose an error.

In another embodiment of a method, the processing logic generates multiple setpoints for controlling a pneumatic controller that is mechanically connected to the processing logic of the electromechanical control section. The multiple setpoints define a deadband, and include a heating setpoint and a cooling setpoint. The processing logic controls the pneumatic controller to vary a pressure of the pneumatic controller in response to the setpoints. In one embodiment, the pneumatic controller is a conventional mechanical pneumatic controller without deadband functionality. By mechanically coupling the electromechanical control section, having the processing logic, deadband functionality can be achieved, as well as energy savings. Alternatively, the processing logic can control a deadband pneumatic controller that already has deadband functionality, and the processing logic can provide enhanced functionality and energy savings.

In another embodiment of the method, the processing logic is integrated into a deadband pneumatic thermostat and tracks an ambient temperature with the deadband pneumatic thermostat. Based on the tracking, the processing logic generates a mechanical output to adjust the pneumatic controller to maintain a neutral output pressure when the ambient temperature is within the specified deadband. When the ambient temperature is not within the specified deadband, the processing logic stops the adjusting to allow a feedback system of the pneumatic controller to resume normal control of the pressure of the pneumatic controller. In another embodiment, the processing logic adjust a position of a control arm of the pneumatic controller to maintain the neutral output pressure when the ambient temperature is within the specified deadband using a motorized cam mechanically coupled to the control arm. In another embodiment, the processing logic generates the mechanical output by actuating a pneumatic solenoid valve to bypass a normal pressure control of the pneumatic controller to maintain the neutral output pressure when the ambient temperature is within the specified deadband. When the ambient temperature is not within the specified deadband, the processing logic adjusts a position of a control arm of the pneumatic controller to the cooling setpoint using a motorized cam mechanically coupled to the control arm, and turns off the pneumatic solenoid valve in order to resume normal control of the pressure of the pneumatic controller.

In another embodiment of the method, a server having additional processing logic remotely monitors, calibrates, and dynamically adjusts the deadband pneumatic thermostat, such as to dynamically adjust the deadband of the deadband pneumatic thermostat (e.g., generating a new set of deadband setpoints). Alternatively, the processing logic can dynamically adjust the deadband. In another embodiment, the processing logic receives input at the device to define the heating and cooling setpoints. These setpoints may be received from a local user interface or from a network interface via a network to which the deadband pneumatic thermostat is communicatively coupled.

Dynamic calibration of the setpoints can be done automatically and without user interaction at the deadband pneumatic thermostat. In one embodiment, the processing logic measures a first pressure of the pneumatic controller, and adjusts a position of a control arm by a known distance using a motorized cam drive mechanism. The processing logic measures a difference in pressure between the first and second pressures with respect to the known distance as a new gain value. This value can be stored and updated periodically. In one embodiment, the processing logic dynamically calibrates by automatically tracking an ambient temperature to prevent a need for manual screw adjustments to define an idle pressure setpoint. Alternatively, the processing logic can perform additional methods as described herein.

As noted above, wireless pneumatic thermostat (WPT) device embodiments may include a mechanical controller and a self-contained power section. Such a mechanical controller may be compatible with existing fittings at a site. Further, because a WPT device may have a self-contained power section, WPT device embodiments may be installed in lieu of existing mechanical pneumatic thermostats without having to rewire the site to provide a power supply input.

Embodiments of the present invention, described herein, include various operations. These operations may be performed by hardware components, software, firmware, or a combination thereof. As used herein, the term “coupled to” may mean coupled directly or indirectly through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Certain embodiments may be implemented as a computer program product that may include instructions stored on a computer-readable medium. These instructions may be used to program a general-purpose or special-purpose processor to perform the described operations. A computer-readable medium includes any mechanism for storing or transmitting information in a form (e.g., software, processing application) readable by a machine (e.g., a computer). The computer-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory, or another type of medium suitable for storing electronic instructions. The computer-readable transmission medium includes, but is not limited to, electrical, optical, acoustical, or other form of propagated signal (e.g., carrier waves, infrared signals, digital signals, or the like), or another type of medium suitable for transmitting electronic instructions.

Additionally, some embodiments may be practiced in distributed computing environments where the computer-readable medium is stored on and/or executed by more than one computer system. In addition, the information transferred between computer systems may either be pulled or pushed across the transmission medium connecting the computer systems.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method, comprising:
generating with an electromechanical control device, mechanically coupled to a pneumatic controller, a plurality of setpoints for controlling the pneumatic controller within a specified deadband, wherein the plurality of setpoints comprises a heating setpoint and an cooling setpoint for the specified deadband for the pneumatic controller; and
varying a pressure of the pneumatic controller in response to the plurality of setpoints.

2. The method of claim 1, wherein the pneumatic controller is a mechanical single setpoint pneumatic controller without deadband functionality, and the method further comprises mechanically coupling the electromechanical control device to the mechanical single setpoint pneumatic controller to achieve the deadband functionality and energy savings.

3. The method of claim 1, wherein the pneumatic controller is a mechanical deadband pneumatic controller, and wherein the method further comprises mechanically coupling the electromechanical control device to the mechanical deadband pneumatic controller to achieve enhanced functionality and energy savings.

4. The method of claim 1, wherein the electromechanical control device and pneumatic control are integrated into a deadband pneumatic thermostat, and wherein said varying comprises:
tracking an ambient temperature with the deadband pneumatic thermostat;
based on said tracking, generating a mechanical output to adjust the pneumatic controller to maintain a neutral output pressure when the ambient temperature is within the specified deadband; and
when the ambient temperature is not within the specified deadband, stopping said adjusting to allow a feedback system of the pneumatic controller to resume normal control of the pressure of the pneumatic controller.

5. The method of claim 4, wherein said generating the mechanical output comprises adjusting a position of a control arm of the pneumatic controller to maintain the neutral output pressure when the ambient temperature is within the specified deadband using a motorized cam mechanically coupled to the control arm and electrically coupled to the electromechanical control device.

6. The method of claim 4, wherein said generating the mechanical output comprises:
actuating a pneumatic solenoid valve to bypass a normal pressure control of the pneumatic controller to maintain the neutral output pressure when the ambient temperature is within the specified deadband; and
when the ambient temperature is not within the specified deadband,
adjusting a position of a control arm of the pneumatic controller to the cooling setpoint using a motorized cam mechanically coupled to the control arm and electrically coupled to the electromechanical control device, and
turning off the pneumatic solenoid valve in order to resume normal control of the pressure of the pneumatic controller.

7. The method of claim 1, wherein the electromechanical control device and pneumatic control are integrated into a deadband pneumatic thermostat, and the method further comprises remotely monitoring the deadband pneumatic thermostat.

8. The method of claim 1, wherein the electromechanical control device and pneumatic control are integrated into a deadband pneumatic thermostat, and the method further comprises dynamically adjusting the deadband of the deadband pneumatic thermostat, wherein said dynamically adjusting the deadband comprises generating a new set of setpoints.

9. The method of claim 8, further comprising remotely controlling said dynamically adjusting the deadband.

10. The method of claim 1, wherein the electromechanical control device and pneumatic controller are integrated into a deadband pneumatic thermostat, and the method further comprises receiving input at the electromechanical control device to define the heating setpoint and the cooling setpoints, wherein said receiving comprises receiving the input from at least one of a local user interface or a network interface via a network to which the deadband pneumatic thermostat is communicatively coupled.

11. The method of claim 1, further comprising dynamically calibrating the plurality of setpoints without user interaction at the electromechanical control device.

12. The method of claim 11, wherein said dynamically calibrating comprises:
measuring a first pressure of the pneumatic controller;
adjusting a position of a control arm of the pneumatic controller by a known distance using a cam drive mechanism;
measuring a second pressure of the pneumatic controller after said adjusting; and
recording a difference in pressure between the first and second pressures with respect to the known distance moved by the cam drive mechanism as a new gain factor.

13. The method of claim 1, further comprising automatically tracking an ambient temperature to prevent a need for manual screw adjustments to define an idle pressure setpoint.

14. An apparatus, comprising:
an electromechanical control device to be mechanically coupled to a pneumatic controller, wherein the electromechanical control device comprises:
a prime mover configured to apply a plurality of setpoint forces in response to a plurality of control signals, wherein the pneumatic controller varies a pressure of the pneumatic controller in response to the plurality of setpoint forces; and
a deadband setpoint controller is configured to generate the plurality of control signals for controlling the pneumatic controller within a specified deadband in response to setpoint control data, wherein the plurality of setpoints comprise a heating setpoint and an cooling setpoint for the specified deadband, and wherein the pneumatic controller is configured to vary a pressure of the pneumatic controller in response to the plurality of setpoints.

15. The apparatus of claim 14, wherein the electromechanical control device and pneumatic controller are integrated into a deadband pneumatic thermostat, and wherein the deadband pneumatic thermostat comprises a temperature dependent displacer mechanically coupled to the setpoint force that provides a mechanical output to a flow regulator of the pneumatic controller, the mechanical output varying in response to an ambient temperature.

16. The apparatus of claim 14, further comprising a wireless temperature sensor communicatively coupled to the electromechanical control device, wherein the wireless temperature sensor is disposed near an HVAC vent on which the pneumatic controller is acting and is configured to measure an ambient temperature near the HVAC vent, and wherein the electromechanical control device uses the ambient temperature to adjust a control pressure in case the control pressure was incorrectly set or if the control pressure drifts over time.

17. The apparatus of claim 14, wherein the electromechanical control device further comprises a communication circuit, communicatively coupled to the deadband setpoint controller, wherein the deadband setpoint controller uses the communication circuit to communicate with another device.

18. A deadband pneumatic thermostat, comprising:
a pneumatic regulator section; and
an electromechanical control section mechanically coupled to the pneumatic regulator section, the electromechanical control section comprising a deadband setpoint controller configured to generate a heating setpoint and a cooling setpoint of a deadband of the pneumatic regulator section, track an ambient temperature, and generate a mechanical output to adjust the pneumatic regulator section to maintain a neutral output pressure when the ambient temperature is within the deadband.

19. The apparatus of claim 18, further comprising a cam drive mechanism, controlled by the deadband setpoint controller, to adjust a position of a control arm of the pneumatic regulator section to maintain the neutral output pressure when the ambient temperature is within the deadband.

20. The apparatus of claim 18, further comprising at least one of a solenoid, a pneumatic switch, or a valve, controlled by the deadband setpoint controller, to switch a fixed regulator into bypass a normal pressure control of the pneumatic regulator section to maintain the neutral output pressure when the ambient temperature is within the deadband.
